(19) United States
(12) Patent Application Publication
(10) Pub. No.: US 2019/0147504 A1
(43) Pub. Date: May 16, 2019

(54) ELECTRONIC DEVICE POST-SALE SUPPORT SYSTEM

(71) Applicant: James Duane Bennett, Hroznetin (CZ)

(72) Inventor: James Duane Bennett, Hroznetin (CZ)

(21) Appl. No.: 16/249,763

(22) Filed: Jan. 16, 2019

Related U.S. Application Data
(62) Division of application No. 14/720,924, filed on May 25, 2015.
(60) Provisional application No. 62/002,597, filed on May 23, 2014.

(51) Int. Cl. G06Q 30/02; G06Q 30/00

(52) U.S. Cl. CPC G06Q 30/0278; G06Q 30/016

(57) ABSTRACT

A system comprises a device under test, a testing device coupled to said device under test via a direct connection, and a post-sales support server communicatively coupled to said testing device via a wide area network connection. The testing device is operable to collect, from said device under test via said direct connection, responses to test stimuli generated in accordance with test code. The testing device is operable to provide said responses to said post-sale support server. The post-sale support server is operable to generate a valuation of said device under test based on said responses, and make said valuation available to a user of said device under test. The valuation may comprise a monetary value based offer associated with third party repair, resale and recycling.

### PRIORITY CLAIM

This application is a divisional of U.S. patent application Ser. No. 14/720,924 titled “Electronic device post-sale support system” and filed on May 25, 2015, which claims priority to U.S. provisional patent application 62/002,597 titled “Electronic device post-sale support system” and filed on May 23, 2014. The entirety of each of the above-referenced documents is hereby incorporated herein by reference.

### BACKGROUND

Many cell phones, tablets and other user devices are regularly discarded and replaced for a variety of reasons. Some devices break down while others are incorrectly believed to have broken down. Others are discarded when a new model hits the market. Devices are sidelined after short to long periods of light to heavy usage. Some are handled roughly while in use, while others exhibit a rather new look and feel.

Although discarded devices have value, they are often initially stored in boxes and drawers then end up in landfills. To attempt to gain access to such value, markets have emerged that provide opportunities for repair, recycling and resale. Getting owners to participate however has proven problematic. For example, visiting or mailing in to a repair service often fails to occur due to associated expectations of unreasonably high repair costs. Attempting to locate and drive to a recycling drop off point provides little incentive. Resale valuations are also difficult to access and without a full mail in process, estimates are often untrusted.

Online services advertising repair, resale and recycling of discarded devices exist which provide rough estimates for repair and resale value. They often only provide firm offers after an owner mails in or drops off their device. Again, because of trust issues relating to such estimates along with associated owners' efforts, such services are often avoided. Knowing this, some resale companies provide kiosks wherein phones may be plugged in, photographed, tested, and assessed to identify a firm dollar value that is offered for an on the spot trade. An owner has little time to think things over, is often unaware of a competing repair cost through a separate service center interaction, and thus often makes an uniformed and rash decision.

Kiosk based resale companies collect phones from their kiosks and send them to servicing centers for data removal, updating and repair before offering them as used, refurbished products through resale channels such as eBay. Even so, as with visiting a repair shop or recycling bin, many owners imagine that such a process is likely not worth the effort, e.g., repair cost too high, resale value offer too low, or locating a recycling bin bothersome. Moreover, without receiving valuations from all outlets (recycling, repair, resale), it is difficult to determine a best way to handle a discard.

Many other limitations and disadvantages of conventional systems for post-sale support and management of electronic devices will become apparent to one of skill in the art, through comparison of such systems with some aspects of the present invention as set forth in the remainder of the present application with reference to the drawings.

### BRIEF SUMMARY OF THE INVENTION

Systems and methods for electronic device post-sale support, substantially as shown in and/or described in connection with at least one of the figures, as set forth more completely in the claims.

Advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 depicts an electronic device post-sale support infrastructure.

FIG. 2A depicts an example client device of a post-sale support (PSS) system.

FIG. 2B depicts an example server or servers of a PSS provider.

FIG. 2C depicts an example administrator device of a PSS provider.

FIG. 2D depicts example server(s)/device(s) of an affiliate of a post-sales support provider.

FIG. 2E depicts an example administrator device of a PSS affiliate.

FIGS. 3A and 3B depict an example graphical user interface of a PSS system.

FIGS. 4A and 4B illustrate example communication topologies/configurations of a PSS system.

FIG. 5 is a flowchart illustrating testing of a client device in post-sale support system to support valuation based on the test results.

FIG. 6A is a flowchart illustrating testing of a client device in a post-sale support system.

FIG. 6B is another flowchart illustrating testing of a client device in a post-sale support system.

FIG. 7 is a flowchart illustrating a backup and restore/cloning service of a PSS system.

FIG. 8 is a flowchart illustrating a targeted offerings service of the PSS system.

FIGS. 9A-10C illustrate testing a PSS client device for physical defects/damage.

FIG. 11 illustrates example components of a PSS client device, each of which may itself be tested and/or assist in testing other components of the PSS client device, as part of the functional and cosmetic testing service of the PSS system.

FIG. 12 illustrates a process for automatic damage prediction, prevention, and remediation.

FIGS. 13A illustrates work-arounds in response to a display or touchscreen defect.

FIGS. 13B illustrates work-arounds in response to a failure of a physical control.

FIG. 14 illustrates a device comprising configured for reducing fall/drop damage.

### DETAILED DESCRIPTION OF THE INVENTION

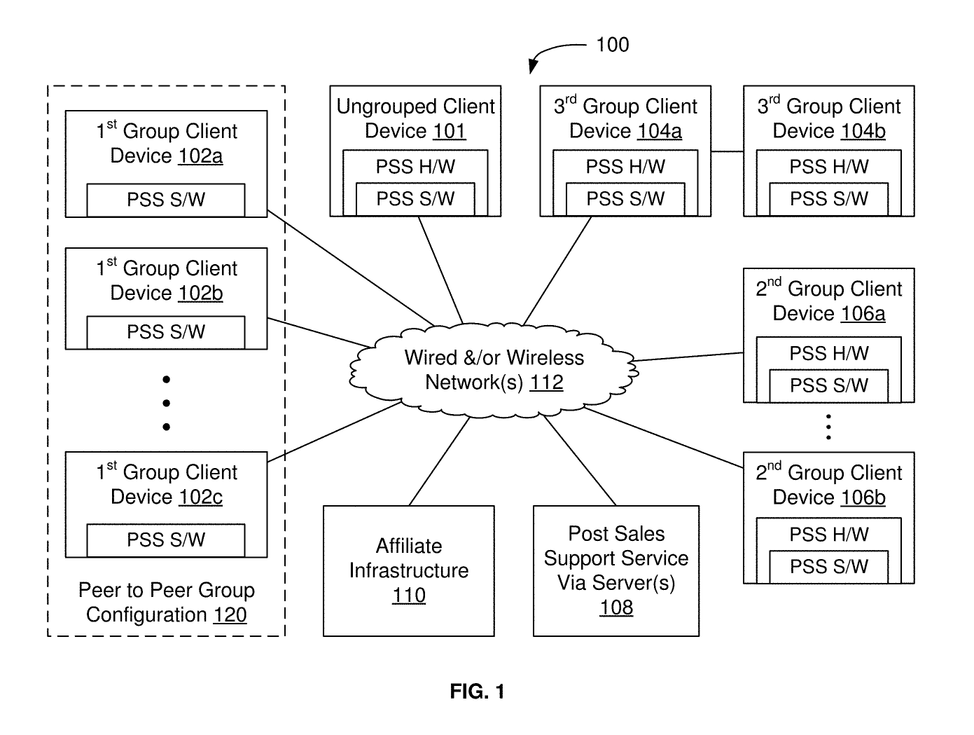

FIG. 1 depicts an electronic device post-sale support system. Shown are post-sale support (PSS) client devices 102a-c, 101, 104a-b, and 106a-b; post-sales support (PSS) service (e.g., PSS server(s) 108), and affiliate systems and/or server(s) 110 interconnected via network(s) 112. The PSS system can target one particular manufacturer's or one particular operator's product offerings, e.g., via PSS servers managed by such manufacturer or operator. Alternatively, the PSS system may span many manufacturers' and operators' product offerings to service users that each have a plurality of client devices that they would like a single PSS management solution for each of their many devices of different manufacturer and operator origin. For example, a user may have a business phone from one operator, a personal phone from a second operator, a tablet from a first manufacturer, a wearable from a second manufacturer, and a laptop from a third manufacturer. Such client devices can all be managed under a single PSS service via the PSS server(s) 108. Such PSS services include but are not limited to provided post sales testing, defect prediction, defected prevention, defect work-around, automated repair (work-around and upgrade code), linkages to repair affiliates, repair cost estimation, current valuation for trade-ins, gathering operational statistics (status, hours in use, etc.), and reach through and substitute proxy operations.

Each PSS client device, such as any of 101, 102a-c, 104a-b, and 106a-b integrates/interacts with the PSS server 108 according to post sales support program code instructions (“PSS code”) running on processing circuitry (not shown) within each PSS client device. PSS code can be found in whole or in part within a downloaded PSS App (a “native” software application), web browser and (test) script based (e.g., java or browser executable format add-on), (secure) firmware, and/or integrated within the client device OS (operating system). The various client devices depicted in FIG. 1 illustrate some examples of many ways one or more groups of client devices might operate/interact within the PSS system 100.

A first user may have only a single client device 101 (e.g., a smartphone) that receives services from the PSS server(s) 108. The client device 101 might interact through a web page and browser-based interface as served up by the PSS server(s) 108. Initially, a user might interact via the network(s) 112 (e.g., the Internet) using a browser that runs on the client device 101. Such interaction causing web page and test related code (e.g., testing and/or test data gathering instructions) to be delivered to the client device 101, and with test data, test results, status information, user and device profile information also being exchanged. Such delivery can be a single exchange but can also occur in stages as needed. For example, first test code portions determining a make and model of the client device 101 and a first web page asking for user account setup or login information. Subsequent code tailored for that make/model might then be delivered, and subsequent web pages may offer test results, recycling and/or replacement values, repair costs, instructions for implementing work-arounds for detected failures, and so on.

A second user may have a plurality of client devices, such as a smartphone, tablet, laptop, smartwatch, “smart home” device (e.g., thermostat), or the like that together receive a peer type service from the PSS server(s) 108. Such peer type service provides a group service wherein each of the client devices 102a-c can inspect status of any other of the client devices 102a-c. In addition, any of the client devices 102a-c can interact for or through any of the other of the client devices 102a-c. Such interactions and inspection operate in a secure, peer-to-peer fashion directly between the devices 102a-c so as not to expose or burden the PSS server 108 with processing and security related issues. Users can comfortably interact, client device to client device, with data and identity anonymity maintained. The setup of such interaction and inspection environment though can be carried out fully between devices or in whole or in part through assistance of the PSS server 108 and PSS application client side code.

More specifically, each of the PSS client devices 102a-c is placed in a monitored and managed mode via application program code (e.g., an App Downloaded from 108 or from an independent App store). As mentioned, such code might also be pre-installed (e.g., by a manufacturer or operator) as an App or comprise, in whole or in part, functionality directly integrated within an operating system of the devices 102a-c. Similarly, the App can be exchanged from one of the client devices 102a-c to the other devices 102b-c, or one of the client devices running the code might service the others in a server-client manner. Various PSS functionality is provided by the program code with assistance from the PSS server(s) 108. For example, any of the PSS client devices 102a-c can (i) see its own test status, (ii) see its repair/replacement/recycling cost/value, and (iii) initiate and/or service call forwarding. Any can also see other peers repair/replacement/recycling value and test & activity status/info. Also, any first one of the PSS client devices 102a-c can share hardware and/or software resources with a second one of the PSS client devices 102a-c to provide a work-around for a failure in the second one of the PSS client devices 102a-c.

A third user might enlist PSS services for two of their client devices in a daisy chained, tethered, master/slave or server/client manner. For example, the client devices 104a-b are arranged such that the client device 104a performs all interactions with the PSS server 108 on behalf of itself and for the client device 104b. In other words, the devices 104a-b are configured for peer-to-peer interactions with the device 104a acting as a proxy for the device 104b which may have no means for directly communicating with the PSS server(s) 108 (either because it was never equipped with such functionality or because of a failure in the device 104b). The client device 104a might be a smartphone and the client device 104b might be a wearable device or a tablet, for example. The client device 104a may register itself and the client device 104b with the PSS support server 108, support interchanges between the PSS server(s) 108 and the client device 104b, directly interact to share PSS related information between itself and the client device 104b, provide work-around software and/or hardware for a failure in the device 104b, all securely and anonymously (without certain underlying private device and user information being shared with the PSS servers 108). Some types of data may also be communicated to the PSS server(s) 108 for storage and/or to support relaying between the devices 104a-b. Users can configure what type of information they consider private and configure communication pathway flow for such types to be either direct (between the client devices 104a-b) and/or indirect (via deliveries to the PSS server 108).

Each of client devices 104a-b is configured to switch between browser-based interactions and App-based interactions per user, App or group device originating request (mode switching). For example, a user of PSS client device 104a may use the client device 104a in App mode to see a persistent widget (icon) item conveying the status (value/cost/etc.) of device 104a and may use a browser mode to view peer counterpart data of the peer device 104b (e.g., to “manage” the peer client device).

The connection between any of the group client devices may be via a network such as the network(s) 112 (either involving or not involving the PSS server(s) 108) or may be a direct connection (e.g., USB or Bluetooth or NFC or ad-hoc Wi-Fi or other connection via which the devices can communicate directly without intervening switches, routers, etc.) and may provide supply power (e.g., USB or NFC). As used herein, a “tether” is a connection via which data can be communicated while concurrently delivering supply power such that hardware can be powered and probed even when the tethered device is seemingly inoperable. For example, device 104a might be a PC/Tablet that uses USB/BT/NFC or other wired or wireless link with a device 104b that is a smart phone. This configuration may be particularly useful when the client device 104b is a wearable, low power, or limited communication capability device.

In some configurations, a first group client device (or several group devices) can be used to carry out the testing of a second group client device, with or without real time assistance of the PSS server(s) 108. Such testing and “probing” by the first group client device can be carried out periodically and upon user triggering, defect detection, etc., via a communication link with the second group client device. Such probing/testing can occur even when the second group client device is at least somewhat inoperable or powered down and solely via interactions with and by the first group client device. During testing, upon detecting a failure in the second group client device that would preclude further testing, hardware and/or software of the first group client device may be substituted for the failure component in the second group client device to work-around the failure and facilitate more complete testing. Similarly, in another configuration, the second group client device (based on defect detection, user interaction, periodically) can initiate the first group client device's testing of the second group client device. In other words, testing and probing can be initiated and carried out in whole or in part by either the testing/probing device or the tested/probed device. Testing and probing routines (program code) can be executed internally by the second group client device, and/or can be executed on the first group client device. In this way, devices in a group can monitor and test each other and themselves and share probing and testing results amongst each other and, if so configured, with the PSS service (e.g., the server(s) 108). Likewise, the PSS server(s) 108 may also initiate testing/probing upon log-in, periodically, or when so requested by either the testing/probing client device or client device to be probed/tested.

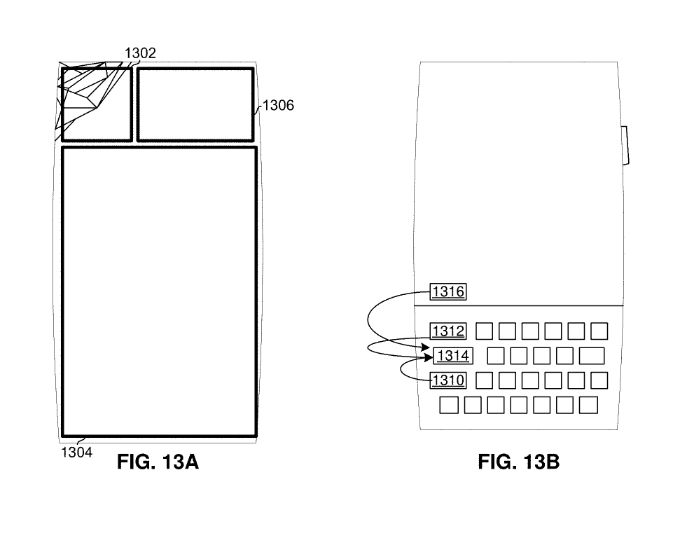

The PSS service provides a variety of supplemental information relating to the user profile, device profile (or device profiles if user registers a group of devices), and based on probing/testing results. For example, if the device 104a reports a problem with the device 104b, the server(s) 108 might respond by delivering a revised current value, a service cost, affiliate service link, work-around-code, etc. Such information might be communicated directly to the client device 104b, device 104a or both. The work around code, intended for the processing circuitry of the device 104b, might assist in addressing, at least a temporarily, the problem detected. For example, as further described below with respect to FIG. 13B, a bad power button or mechanical key might be replaced or supplemented with a different means for capturing such user input. For example, three shakes of a device with a bad power button may act to power on or off the device. Or a voice input being useable in replacement. Similarly, as further described below with respect to FIG. 13A, a broken screen in one corner of the device may be countered at least temporarily by restricting the screen output to one or more regions of the screen area that are free from visual obstruction. A detected defect in one of a stereo speaker output might end up being at least temporarily corrected with a mono-audio output through a single speaker. Similarly, if audio frequency response of a punctured or partially operating speaker is detected from microphone captures of sound test data, adjustments of normal audio frequency response/output can be adjusted so as to minimize the effect of some defect or damage in the audio system. The work-around program code and underlying hardware support thereof can be built in to the device under testing/probing. The work-around program code can also run on the testing/probing device and/or on the server(s) 108.

Beyond allowing the device 104a to take on most or all of the PSS duties such as testing and interaction with the server(s) 108, a tether between the devices 104a-b provides several other advantages. Many devices 104b that fail can end up being fully inoperable. For example, when the processing circuitry fails or batteries fail to recharge, a USB (universal serial bus), NFC (near field communication, or POE (power over Ethernet) tether (or other power-delivering wired or wireless link), for example, might be used to direct power to all or parts of a substantially dysfunctional device 104b. For example, NFC, RF tags, and resonant or inductive power transfer mechanisms might be used to deliver power while retrieving status information, placing a portion or all of a device under probing or testing, directing delivered work-around code or software upgrades, retrieve device simulation data, etc.

A power management circuit associated with a tether might then receive test commands which control both the testing and power delivery of internal circuit sections of the device 104b. In this way, the circuit portions under probe/test can help identify problems and help reach repair pricing conclusions that affiliated service companies can use to more accurately perform their price estimation. In addition, manufacturers often do not get sufficient failure information as repair affiliates often just swap boards and batteries without needing to perform thorough testing. Thus, it proves difficult for manufacturers to identify redesign needs to address such failures. By communicating the accurate testing/probing data obtained using a tether, manufacturing affiliates can gather such information for such purpose. In addition, with such accurate testing, software and battery pack issues can be more accurately detected so that service can be carried out without having to send in a device for servicing. Software can be replaced, firmware updated and batteries mailed. Also assisting this process for repair and current device value involves particular device profile information that can be gathered directly from memory that is accessible via the power-delivering connection (even when the device is unable to power up).

For example, a user may interact via the client device 104b to sign up for PSS servicing via web browser or downloaded App, and through interacting with the PSS server(s) 108. Thereafter, the user might find an old and unused device 104b with a lost power charging connector in the back of drawer. By tethering the client device 104a to the device 104b, the client device 104a through interaction with the server(s) 108 can gather appropriate probing and testing code for the device 104b. That is, via a USB or NFC tether, for example, memory probe, the make/model/configuration of the device 104b can be retrieved. With this information, the device 104a can then interact with the server(s) 108 to gather testing and probing information and program code that targets such make/model/configuration. Then, the device 104a can begin to probe/test the device 104b to determine its status, value, costs to repair (if any), wear and tear (prior usage), and so on. A profile for the device 104b can also be created on the server(s) 108 so that future interaction between the device 104a and the device 104b can be streamlined. After probing/testing, cross device management code can be installed on the device 104b (already present on 104a upon initial setup of the device 104a). Work-around and repair/upgrade code can be delivered as well from the server(s) 108 to the device 104b (via the device 104a). Repair, replacement, current value type advertising (selected based on the probe/test results plus the profiles of the device 104b and the user) can also be delivered to either or both the devices 104a-b.

Such testing code might then operate on the client device 104a versus (or in addition to) testing code running on the client device 104b (the device under test). When the client device 104b operates normally, such configuration may not need to be used for some or all testing of the device 104b. Instead, testing code or commands might flow directly from the wireless networks 112 to the device 104b via a direct link (not shown). Nonetheless, even where the device 104b appears to be operating normally executing test code on a tethered device (e.g., 102a) to perform/control testing of the device 102b may be useful in detecting hardware and/or software failures that cannot be detected by executing test code on the device 102b (e.g., because malware is masking the problem or because the test code requires placing some hardware and/or software of the device 102b into a state that renders the device 102b unable to execute the test code).

The PSS client devices 106a-106b illustrate that a PSS client device might use only web service interaction and operate only in a monitoring and managing mode, while another client operates only via an App in only a monitored and managed and monitored mode. Further, the client device 106a might be owned and operated by a first user, while the second client device 106b might be owned and operated by a second user. Such first and second users agreeing to operate in a group relationship to receive multi-user, group-wide PSS services from the server(s) 108. An example might be where a family (husband, wife, children) agree to share their device information and can gain cross device access in advance.

The PSS server(s) 108 can thus support many different configurations by sometimes providing substantial server support for browser-based client side modes and sometimes providing possibly minimal server support for App-based client side modes. That is, peer-to-peer interactions can be established between App based client devices via server supported peer setup (e.g., registering and delivering registered IP addresses). After such minimal support (which may also involve security and login and group confirmation before making such deliveries), the PSS infrastructure 108 might take more of a “hands-off” approach for exchanges between the group peer devices. Exceptions may include getting involved to assist in: (i) valuation, (ii) test code delivery, (iii) recycling/repair/replacement valuations, (iv) targeted offerings, etc. Otherwise, status, forwarding, call/usage/performance monitoring data might be only exchanged directly (and securely—crypto) between group devices. Alternatively, in other user device group mode configurations, the PSS infrastructure 108 may not be involved in peer-to-peer construct support. Instead, the PSS infrastructure could act as a middle man in all communication flow. In a simple form, this would be to act like a forwarding agent or proxy for the secure data flow exchange mentioned above. In more complex situations, the infrastructure 108 could store all, portions or summaries of the data flow exchange and permit flow exchanges to occur outside of real time situations. In other words, one client device might send status info, test data, etc., to the infrastructure 108 which could then be stored for future access by either such client device or another such device in a preauthorized group.

The affiliate infrastructure 110 includes devices (servers and/or client devices) of one or more affiliates of the PSS provider. For example, affiliates may include one or more of: a client device repair/servicing entity; a client device recycling entity, an entity that operates to perform trade-ins and/or sales of new or used devices; a carrier/operator (e.g., AT&T, O2, Verizon, etc.) that provides network access to client devices; an online retailer; an online marketplace (e.g., Amazon, eBay, etc.) that enables consumers to buy/sell/trade client devices, and/or the like. The affiliate infrastructure 110 may deliver information regarding the products and/or services in which the affiliates deal on a real-time, periodic, and/or event-driven basis. For example, for repair, recycler, and/or reseller affiliates, the affiliate infrastructure may deliver current cost/price lists for client devices, where the costs/prices are determined based on cost/price-relevant characteristics of the client devices, and may deliver code or rules for use by the PSS infrastructure 108 in (i) testing the PSS client devices to determine the cost/price-relevant characteristics of the PSS client devices; (ii) exchanging order information between or among affiliates and PSS client devices; and (iii) exchanging PSS client usage information, PSS client device configuration information, etc.

The wired and/or wireless network(s) 112 can provide any pathways needed to support such exchanges and interactions. For example, a portion of the network(s) 112 might be considered an Internet network. Another portion might be a cellular network, while others might comprise peer-to-peer communication flow.

In addition to testing/probing, the PSS server(s) and associated overall PSS service (which also includes any client side PSS software and hardware modifications), repair may involve any one or more of software or firmware upgrades, software removal (e.g., malware identification and removal or quarantining), user targeted instructions for carrying out do-it-yourself repair, and work-around code. In addition, the PSS service also supports (i) reach-through operations, (ii) virtual clone service, (iii) locationing, and (iv) theft support. Reach-through operations involve using, for example, the client device 106a which may be remote from the user via the client device 106b.

For example, the client device 106b might be a home laptop of an at-home user that forgot his/her cell phone client device 106a at work. PSS software running on the laptop provides for a status bar icon of the at-work phone which can be clicked on to pop-up a window view which parallels that of the at-work phone. By mouse or screen selections of the icons on the laptop pop-up window, control signals can be communicated by the PSS software to the at-work phone to cause interactions as if the user's input was entered directly into the at-work phone itself. Video and audio information generated on the phone as a result of launched functionality is then communicated back from the PSS software on the work phone to the PSS software on the laptop so as to provide a full “simulation” of the at-work phone on the laptop. Calls that ring in on the remote work phone trigger PSS-software-to-PSS-software interaction resulting in the simulated laptop phone window ringing. Answering interaction on the laptop triggers answering on the phone and so on. App launching and interaction operates similarly. In addition, the at-home device might be a second phone which is simulating operations of the at-work phone. Any device beyond phones can similarly be simulated via this type of reach-through interaction.

In situations where a client device is inoperable in whole or in part, the PSS software elements can also virtualize all or a (dysfunctional) portion of a client device. For example, if battery power begins to fail in the work phone from the previous example, the PSS software may choose to only provide reach-through functionality for a subset of the at-work phone's capabilities. The remainder is handled through virtualization. Similarly, if the battery fully fails, instead of reach-through functionality, full virtualization is implemented. That is, the home laptop is used by the PSS software running thereon to fully (or partially) simulate reach-through functionality itself. This applies to any simulating or reaching-through client device and any type of simulated or reached client device pairing.

For example, to simulate a fully operational left-at-work phone or tablet, an at-home user can interact with a second smartphone and PSS software thereon to reach through to the at-work phone to carry out normal smartphone interactions. If the at-work phone is dysfunctional in part or battery is failing, the second smartphone can virtualize all or part of the at-work phone's normal functionality and reach through for the remainder. Lastly, if the at-work phone is fully dysfunctional or lost, the second smartphone can act as a virtual copy of the at-work phone (even while being able to switch back and forth for the second smartphone's own operations). This will allow a user to casually seek a replacement without having to experience down-time during purchase, repair and shipping times.

Thus, simulation of one client device by another via PSS software support can be carried out via reach-through and/or virtualization approaches independently or in concert as may be optimal for a given situation. Such situation including consideration of both the characteristics of the communication channel in view of underlying payload requirements and the operational states (or lack thereof) of both the simulated and simulating devices. For example, when the simulating device has full power and resources are not being otherwise used, it may choose a first simulation scheme (balance between reach-through and virtualization) to represent a first simulated device requiring a first communication channel impact, while choosing a second simulation scheme to represent a second simulated device with its differing second communication channel requirements. Then, later during such simulations, the simulation schemes may be modified dynamically to address changes that occur on any one of the communication channel, a simulated device, or the simulating device.

Dynamic simulation scheme adaptation is further buttressed with handover underpinnings. That is, as changes occur (geographical movement, channel/device changes related, etc.) or user triggering, an ongoing simulation can be swapped from a first simulating client device to either a second simulating client device or the simulated client device (ending the simulation)—or vice versa. In this way, an ongoing session, media consumption, App interaction, video call, etc., can be swapped back and forth as needed and/or as the user so directs. For example, after testing the client device 104b, the client device 104a can be offered up a simulation function to support a client device 104b that currently has a dead battery. While in mid-simulation, the battery charging may reach a level where the user desires to switch back to the client device 104b and does so by triggering the swap on either of the devices 104a-b.

To carry out virtualization and reach-through operations, manufacturing and operator affiliates can provide for secure linkages and handovers in support. This includes any needed PSS hardware related changes plus PSS software code that is pre-stored and available on the server(s) 108. With such software code, one of the user's client devices can gather relevant configuration information from another of the user's client devices for use in the reach-through and virtualization process. This information can also be stored on the server(s) 108 with appropriate and acceptable security or merely managed locally by each of a plurality of the user's client devices which can then each simulate (reach through or virtualize) each other of the user's client devices when needed.

Such configuration information may include user account information, SIM card or security key information, Apps available, screen layout, data and database information, user (phone) directories, identification and/or status of any failed, or predicted soon-to-fail, hardware and/or software, and any other information/code/data that may be needed to generate the simulation. In addition to storage on each and every one of the client's devices, such storage may exist on the server(s) 108 or in the cloud. In addition to using such storage for simulation, it can be used by the PSS service to reconfigure a replacement device so as to place the replacement device in service in a quick and seamless manner. To this end, the server(s) 108 also provide translation services to support scenarios where a user upgrades or switches operator or manufacturer when choosing a replacement for a broken device.

The affiliate infrastructure 110 includes affiliates such as client device manufacturers, resellers/recyclers, operators, salvagers (e.g., grind up or otherwise disassemble phones into resalable constituent parts), replacement retailers, do-it-yourself-repair-element retailers, data miners, advertisers, etc. The PSS server(s) 108 provide both anonymous and user identified interfacing between all users, user devices, and affiliates. Such interfacing involving upgrade, work around, testing/probing code exchanges delivered in a M2M (machine to machine) manner, as well as human based interactions such as user launched requests for service, trade-in, or replacement purchasing. Choosing to allow for piercing of anonymity can be placed in the user's hands (through configuration or upon making a particular request to a particular affiliate), or provided to a data miner or other affiliate with user delivered notice. For example, testing code can be delivered from a repair shop (directly or via the server(s) 108) that is used to identify a defect which is then used to estimate a cost of repair without the repair shop knowing the user or specific device identity. A user can then pierce the anonymity by reaching out to the repair shop to carry out the offered repair transaction. Payment for such transaction can be mediated via the servers 108 or carried out independently between the user and the affiliate (repair shop).

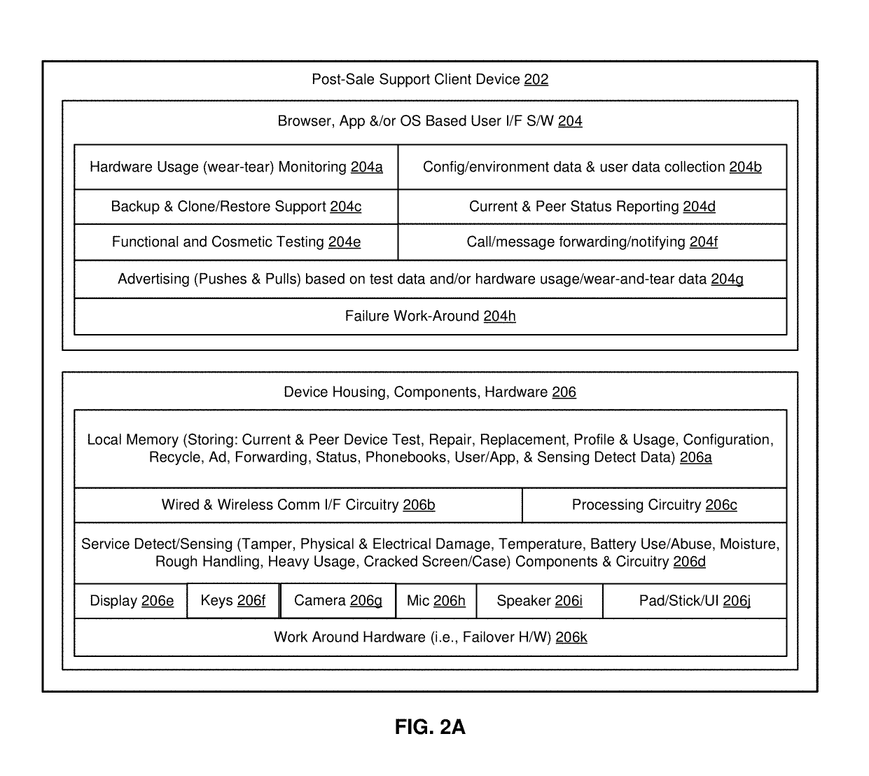

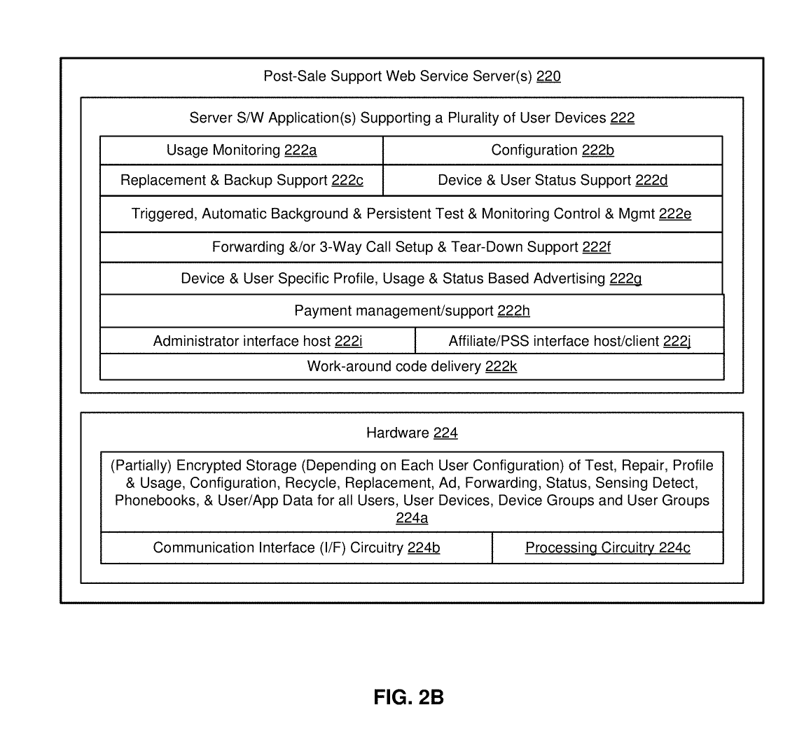

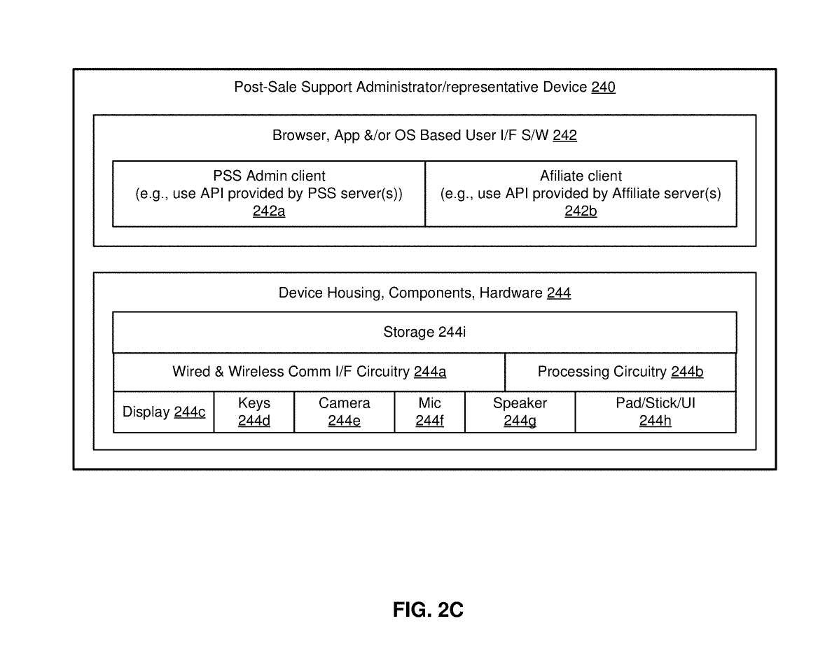

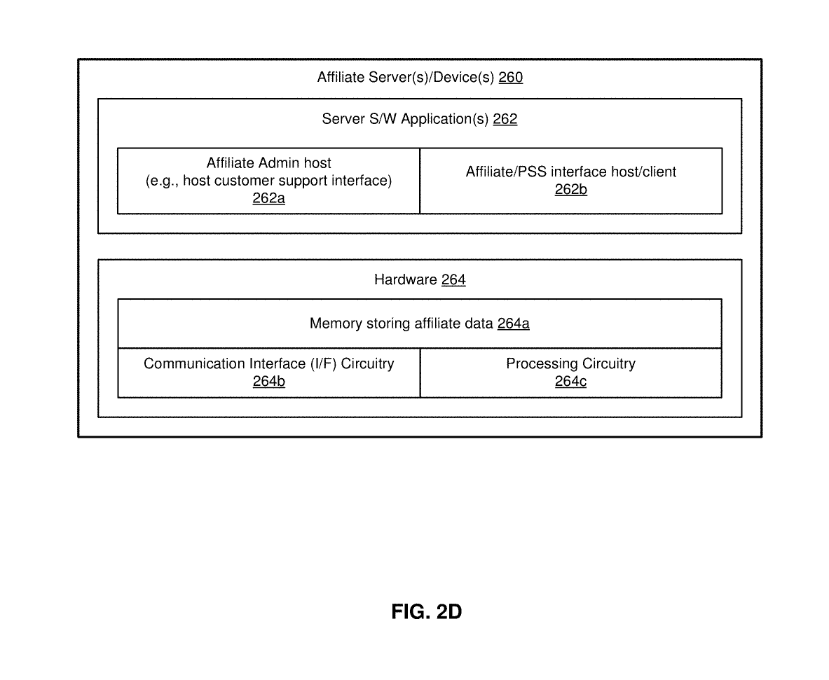

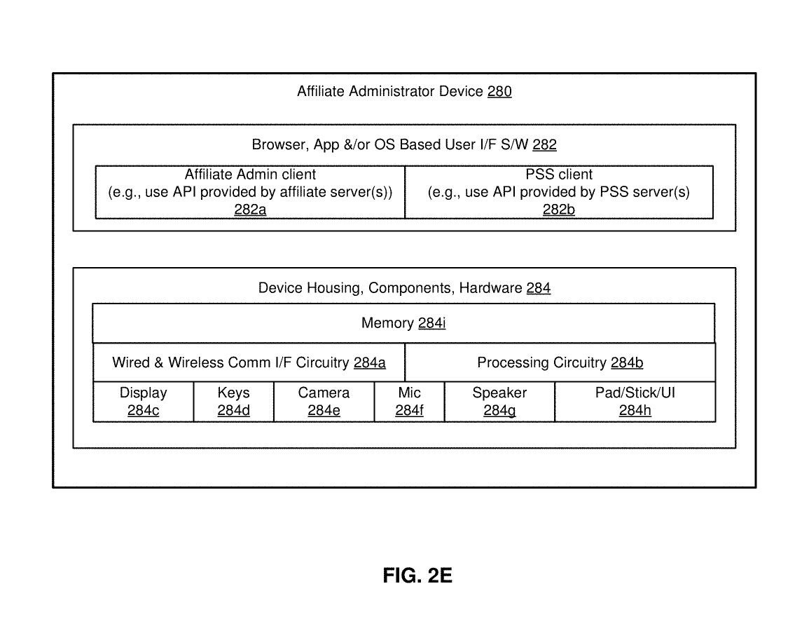

An example implementation of the client devices are described below with reference to FIGS. 2A. An example implementation of the post-sales server(s) 108 is described with reference to FIG. 2B. An example device through which an administrator of the post-sales support server(s) 108 may interact with the server(s) 108 is described below with reference to FIG. 2C. An example implementation of the affiliate server(s) 110 is described with reference to FIG. 2D. An example device through which an administrator of the affiliate server(s) 110 may interact with the server(s) 110 is described below with reference to FIG. 2E.

FIG. 2A depicts an example client device of a post-sale support system. The example post-sale support system (PSS) client device 202 can be placed in either or both of a managing and monitoring mode and a managed and monitored mode. For example, the device 202 may be a PC sitting at home which operates only in a managing and monitoring mode to support a plurality of other PSS client devices that operate in a managed role/mode only. Conversely, as another example, the PSS client device 202 may be a mobile device (e.g., a phone, table computer, or notebook computer) associated with a PSS account that also has associated with it one or more other similar devices as PSS client devices. In this second example, each of the PSS client devices may support both the managing and monitoring mode and the managed and monitored mode, such that they may be used for managing each other. Which role each of the plurality of PSS client devices is in at any given time can be determined on the fly (based on user preferences, based on condition of the devices, etc.). In an example implementation, the PSS client device 202 may default to the managing and monitoring mode to ensure consistent collection of data, for example.

For the PSS client device 202 operating in the managed and monitored mode, the managing and monitoring can be carried out in whole or in part by a web service running on one or more servers such as the server(s) 108. Selection of whether to activate the web service and the amount of PSS management and overall functionality carried out by the web service can be established via configuration settings that are accessible via a device connected to the web service. For example, one user might initially have only a single phone/tablet associated with his/her PSS account and the phone/tablet may perform all underlying functionality locally and with web service support. Later, the user may associate a PC with his/her PSS account (e.g., because the phone/tablet is having problems) and may use the PC to log into the web service and gain access to PSS client device managing and monitoring functions (either via a browser web page interface, browser downloaded program code/add-ons (e.g., java), or via independent downloaded and installed App that operate outside of browsers). Later still, the user may add second tablet/phone and a third tablet/phone to his/her PSS account, and may setup the account such that the three are associated with one another in the PSS account and each can operate in both the managing and monitoring mode and the managed and monitored mode. Thus, at any given time, any functioning device of the three can be used to manage and monitor the other two devices.

The PSS client device 202 comprises software 204 running on hardware 206. The hardware 206 comprises a housing/enclosure, a display (e.g., LCD, OLED, e-ink, or the like) 206e, physical buttons/keys 206f, a camera 206g, a microphone 206h, speakers 206i, and an input device 206j (e.g., touchpad, trackball, joystick, touchscreen, and/or the like) for navigating among elements displayed on the display. The hardware 206 may comprise sensor components 206d that can sense one or more of: tampering with the device 202, physical and electrical damage to the device 202, temperature of the device, battery condition, memory condition, moisture, drops/rough handling, a cracked screen, a cracked case, and/or the like). The output(s) of the sensors may be used for detecting and/or predicting failures of the device 202. The hardware 206 may comprise wired and/or wireless communications interface circuitry 206b. The hardware may comprise processing circuitry 206c (e.g., one or more CPU cores, one or more coprocessors, one or more bus interfaces, and/or the like). The hardware 206 may comprise memory 206a (e.g., SRAM, DRAM, ROM, hard-disk, Flash, and/or the like) which may store data organized into one or more tables, databases, files, and/or the like. The hardware 206 may comprise work-around hardware 206k which may, for example, comprise a redundant instance of hardware installed by the manufacturer of PSS client device 202 (e.g., because it is hardware that is most likely to fail such as a storage system, a power supply, a bus controller etc. and the manufacture has deemed it more cost-effective to include redundant hardware rather than service PSS client devices or replace the devices as a whole). The work-around hardware 206k may, for example, comprise reconfigurable hardware (e.g., an FPGA, a general purpose processor, an EEPROM, and/or the like) which can be configured into any of a variety of configurations by loading/programming it with the appropriate work-around code for emulating whichever software and/or hardware has failed.

Data stored in the memory of the PSS client device 202 may be generated/collected by one or more of: one or more utilities of the operating system of the PSS client device 202, one or more applications installed on the PSS client device 202 by a carrier that provides service to the PSS client device 202, one or more applications installed by a manufacturer of the PSS client device 202, and one or more applications provided by the PSS provider, and one or more application installed by another third party (e.g., a web browser). Data stored in memory of the device 202 may be the result of, and/or used by, one or more functions performed by the PSS client device 202, one or more other PSS client devices associated with the PSS client device 202 in a PSS account, and/or a web service interacting with the PSS client device 202. Examples of such functions are described below. Data stored in memory of the device 202 may comprise, for example, one or more of: general device info (e.g., manufacturer, model, OS version, carrier, subscription plan/status, and/or the like), general user info (e.g., name, address, username for post-sale support system account, and/or the like), user data (e.g., non-system files such as documents, emails, contacts, photos, internet history, and/or the like), software activity logs (e.g., voice call history, data usage history (e.g., categorized by network type); application usage history (e.g., categorized by name and/or type of application, time spent, battery energy consumed, and/or the like); history of offerings that were generated/available but not-viewed, available and viewed, viewed and clicked-through, etc.; location history (e.g., based on GPS, networks connected to or available, and/or the like); data indicating call/message forwarding/notification configuration and status; and hardware usage/wear-and-tear data/logs, one or more of which may be a log of output from one or more of the sensor components.

The software 204 running on the hardware 206 may comprise one or more applications that enable management of the PSS client device 202 and/or enable the PSS client device 202 to manage one or more other PSS client devices. Such applications may include, for example, a web browser, a web browser with PSS add-ons (e.g., JavaScript downloaded from PSS server 108), and/or native application (that runs outside of a web browser) provided by the PSS provider. Execution of the software 204 by the hardware 206 may enable the device 202 to perform services such as: hardware usage/wear-and-tear monitoring 204a, configuration/environment collection/determination 204b, replacement and backup support 204c, device status collection/reporting 204d; device testing 204e, current & peer forwarding/3-way call mgmt 204f; targeted offerings 204 (push and/or pull) based on data resulting from the testing function and/or data resulting from the hardware usage/wear-and-tear monitoring function; and effectuating failure work-arounds 204h.

The hardware usage/wear-and-tear monitoring service 204a may comprise the PSS client device 202 monitoring and logging data for itself (operating in managed and monitored mode or switching between managed and managing and monitoring mode) and/or for one or more other PSS client devices (operating in managing and monitoring mode). The hardware usage/wear-and-tear data may include, for example, internal temperature of the device generally and/or of specific components (e.g., CPU, GPU, bus interface, etc.); average or cumulative load on particular circuitry such as CPU, GPU, bus interface, etc.; impact/drop detections; cracked/broken screen, button, housing, etc. detections; battery charge cycles and/or average charge; audio duration and volume logs for the speaker(s) and/or microphone(s), number of dis/connections of USB, HDMI, and/or other ports, number of pictures taken with/without flash, number of reads/writes to memory, sensor data captured during a possible damage event, and/or the like. Any or all of the hardware usage/wear-and-tear data may be time-stamped such that it can be correlated with test data from test cycles performed before or after the data point. This may help determine whether the data point corresponds to a point of depreciation of the value of the client device and/or cost to repair the client device (e.g., an actual or imminent hardware failure). For example, test may be performed each morning. On the evening of Day 1 an impact/drop sensor detects a large impact to the device that potentially caused some damage. When determining a value of the device, in response to seeing that drop detection, the PSS system may compare test results from the morning of Day 1 (before the impact) and the test results from the morning of Day 2 (first test result available after the impact) to determine whether the impact caused any damage (e.g., whether a screen and/or housing test revealed any possible new cracks). Similarly different usage data points may be correlated against one another. For example, when determining a valuation of the device, in response to the drop detection, the PSS system may inspect a temperature log for any spike in temperature shortly after the drop (a spike in temperature possible indicating that a short circuit resulting from the impact). In this manner, the hardware usage/wear-and-tear data alone and/or in combination with test data may enable an objective estimate of a value of a device or cost to repair a device, rather than relying on input from the owner/user of the device (who is obviously incentivized to exaggerate about the condition of the device in order to maximize the value s/he can receive from an affiliate for trade-in/sale/recycling/etc. of the device) and without having to physically bring the device to an affiliate for inspection/verification of the value of the device. That is, the data may enable an affiliate to make a firm offer (e.g., over the internet) in reliance on the data from the PSS system, without having to be in physical possession of the device and without having to give a cautiously low valuation to account for potential problems unknown or not-disclosed by the owner. The hardware usage/wear-and-tear monitoring may be: self-triggered (e.g., periodically or persistently run in the background, and/or in response to occurrence of particular event(s) such as establishing a peer-to-peer connection with another PSS client device, logging into the PSS web service, an event detected by a sensor of the device, and/or the like), peer-triggered (i.e., triggered by another PSS client device operating as manager of the PSS client device 202), or server-triggered (e.g., triggered by a PSS server, such as the server(s) 108, upon the device logging into the web service). Data gathered as part of the usage monitoring may be natively gathered by a PSS application (e.g., downloaded from the PSS server(s) 108 and/or may be gathered by one or more other utilities or applications on the device 202 (e.g., operating system utilities, applications installed by a device manufacturer, and/or applications installed by a carrier) and then the PSS app or web service may pull data from the log files/data structures maintained by those other utilities/applications. The data may be aggregated, generalized, and/or anonymized before being provided to a server such as the server(s) 108 and/or 110.

The configuration/environment data and user data collection service 204b may comprise collecting data from the PSS client device 202 and/or from one or more other PSS client devices associated with the PSS client device 202 (when the PSS client device operates in managing and monitoring mode for the other device). Configuration/environment data may include, for example, which apps (and versions thereof) are installed on the device, configurations of various OS and/or application settings; organization of folders, icons, home screens, etc.; OS and/or app visual “themes,” and/or any other data that “personalizes: the look, feel, and operation of the device. User data may include, for example, non-system files such as documents, emails, contacts, photos, temporary internet files, and/or the like. The data collection may be: self-triggered (e.g., periodically or persistently run in the background, and/or in response to occurrence of particular event(s) such as establishing a peer-to-peer connection with another PSS client device, logging into the PSS web service, installation of an application, configuration of an OS setting, and/or the like), peer-triggered (i.e., triggered by another PSS client device operating as manager of the PSS client device 202), or server-triggered (e.g., triggered by a PSS server, such as the server(s) 108, upon the device logging into the web service).

The replacement and backup support service 204c may comprise backup of data and, in response to a restore/clone trigger (e.g., failed device, user request), loading that data onto the same device or another device. The storing of data (e.g., configuration/environment data and user data) may be of a client device's data to its own memory, of a client device's data to a locally attached storage (e.g., an external hard drive or optical disk), of a client device's data to the PSS server 108, and/or of a client device's data to another client device (e.g., another client device on the same PSS account or to another device that has been provided with authorization by the owner of the device being backed-up). Which data is backed up may depend on where the data is being backed up (e.g., for security purposes). For example, user data may be only backed up to that user's client device(s) and not to the PSS server 108 while configuration/environment data is backed up to the user's client device(s) and to the PSS server 108. The storing may be: self-triggered (e.g., periodically or persistently run in the background, and/or in response to occurrence of particular event(s) such as establishing a peer-to-peer connection with another PSS client device, logging into the PSS web service, request from a user of the device, and/or the like), peer-triggered (i.e., triggered by another PSS client device operating as manager of the PSS client device 202), or server-triggered (e.g., triggered by a PSS server, such as the server(s) 108, upon the device logging into the web service). For restoring a PSS client device, the device may load its own backed-up data (from wherever the data was stored) along with any scripts/code/etc. necessary to load the configuration/environment data and then reboot for the loaded configuration/environment data to take effect. For cloning a PSS client device, the clone/replacement device (having the appropriate permissions) may load the backed-up data of the replaced/cloned device (from wherever the data was stored) along with any scripts/code/etc. necessary to load the configuration/environment data and then reboot for the loaded configuration/environment data to take effect. Where the replacement device and replaced device are the same make and model, the clone may be straightforward. Where the replacement device is different than the replaced device (e.g., different make, mode, OS, etc.), however, the PSS system may first translate/port the backed-up configuration/environment data to corresponding configuration/environment data suitable for the clone device. In this manner, features that are common between the clone and cloned devices may be the same after cloning and other features may be as close as possible given the differences between the devices. In an example implementation, the cloning feature of the PSS system may be used to enable one user to aid another user in configuring the other user's device. For example, user A borrows user B's phone and loves how user B has customized the configuration/environment of the phone. Accordingly, user B triggers a backup of the configuration/environment data of his phone to the PSS server and the PSS server provides a link to the data. User B then sends the link to User A. User A clicks on the link and cloning of User B's configuration/environment begins on User A's phone this may be fully automated and/or may require input from User A (e.g., to accept purchases of non-free apps that need to be installed in order to complete the configuration/environment cloning).

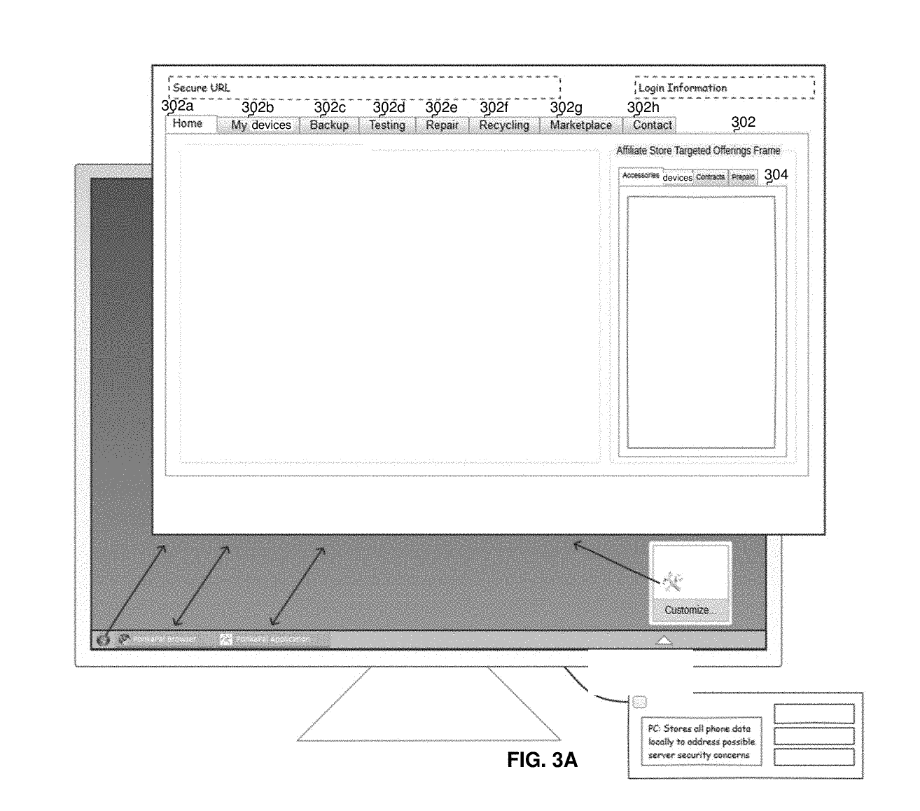

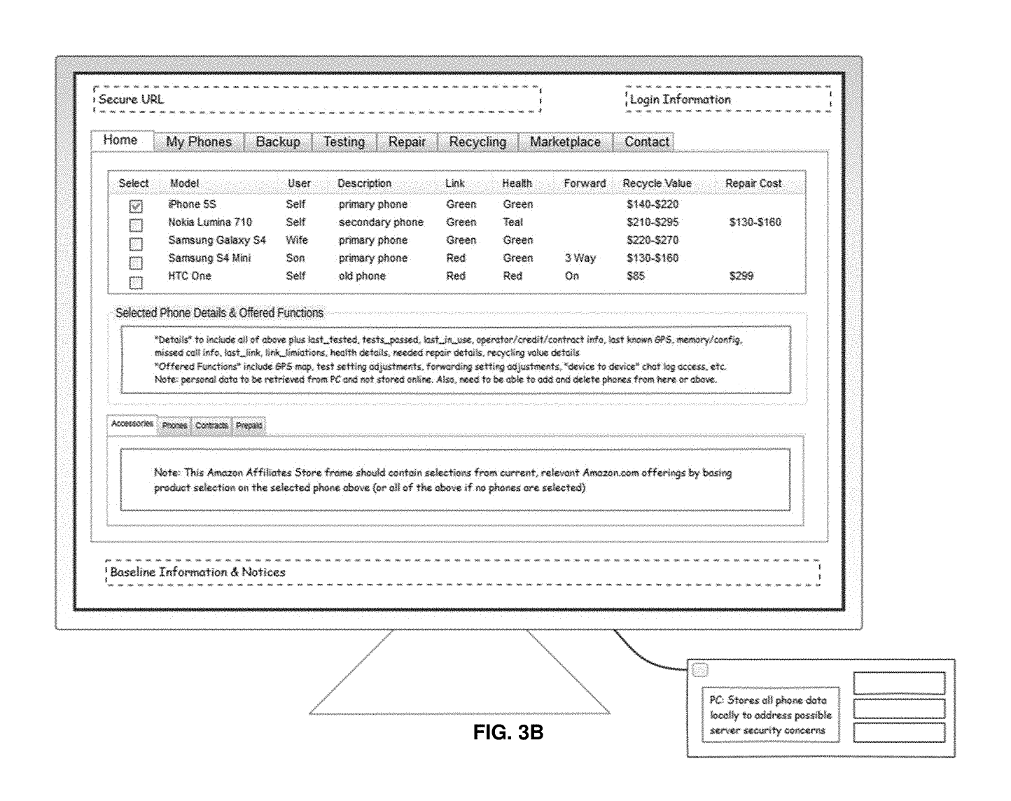

When the PSS client device 202 operates in managed and monitored mode, the device status collection/reporting service 204d may handle the reporting of status data for the PSS client device 202. This may comprise, for example, retrieving the data from memory of the device 202 and presenting it via a GUI (e.g., as shown in FIGS. 3A and 3B) on the device 202 and/or communicating it to another PSS client device and/or PSS server 108 that manage(s) the PSS client device 202. When the PSS client device 202 operates in managing and monitoring mode, the device status collection/reporting function may handle aggregating status data for itself and/or other PSS client devices that it manages, and then presenting the aggregated data via a GUI and/or communicating the data to a server (e.g., 108) which may then present the data via a GUI of the web service. Status data for a device may include, for example, one or more of: general device info, general user info, detected or predicted device problems (“Health”), network connection status (e.g., using connectivity heartbeat that uses GPS and IP address registration), call/message forwarding/notification data (e.g., information about a devices preferences/options for call/message forwarding/notifications, information for how to reach the device for call forwarding/notifications (e.g., IP address, telephone number, etc.), and whether call/message forwarding/notification is active for the device). Status data for a device may also include valuations for the device for each of one or more disposal options (e.g., recycling, resale via online marketplace, direct sale to another PSS user, trade-in to a carrier, and/or the like). In this regard, the device status reporting function may also perform the interactions with affiliates to determine the valuations. Update of the device status data for the PSS client device 202 may be: self-triggered (e.g., periodically or persistently run in the background, and/or in response to occurrence of particular event(s) such as establishing a peer-to-peer connection with another PSS client device, logging into the PSS web service, request from a user of the device, and/or the like), peer-triggered (i.e., triggered by another PSS client device operating as manager of the PSS client device 202), server-triggered (e.g., triggered by a PSS server, such as the server(s) 108, upon the device logging into the web service).

The functional and cosmetic testing service 204e may enable testing to determine functionality of software of the PSS client device 202 and/or connected peer client devices that the device 202 is managing and monitoring, to determine functionality of and/or wear-and-tear on hardware of the PSS client device 202 and/or connected peer client devices that the device 202 is managing and monitoring, and/or to determine the cosmetic condition of the PSS client device 202 and/or peer connected client devices that the device 202 is managing and monitoring. In a first configuration, the testing may be self-testing. In a second configuration, the testing may a first PSS client device operating in managing and monitoring mode and controlling/directing testing of the PSS client device 202 that is operating in managed and monitored mode. In this second configuration, the PSS client device operating in managing and monitoring mode may send test commands to the PSS client device 202 and receive responses to, or results of, the commands from the PSS client device 202. The test commands and responses may be via a wired or wireless peer connection (e.g., USB, NFC, or Bluetooth) or via a network (e.g., with the aid of a server such as the server(s) 108). In the second configuration, the managing and monitoring PSS client device may direct a user/tester to perform actions on the PSS client device 202. The managing and monitoring PSS client device may directly monitor activity in the PSS client device 202 (e.g., via wired or wireless connection) that occurs in response to the actions, and/or the managing and monitoring PSS client device may query the user/tester to report on the results of the actions (e.g., take a picture of the PSS client device 202 after performing the actions, type in (on the managing and monitoring device) a description of how the device 202 responded to the actions, and/or the like). In a third configuration, the PSS client device 202 operating in managed and monitored mode may be tested under guidance/control by the PSS web service. Testing of the PSS client device 202 may be: self-triggered (e.g., periodically or persistently run in the background, and/or in response to occurrence of particular event(s) such as establishing a peer-to-peer connection with another PSS client device, logging into the PSS web service, request from a user of the device, and/or the like), peer-triggered (i.e., triggered by another PSS client device operating as manager of the PSS client device 202), server-triggered (e.g., triggered by a PSS server, such as the server(s) 108, upon the device logging into the web service).

The call/message forwarding/notifying service 204f may enable the PSS client device 202 to configure itself, a peer device, and/or a network service (e.g., provided by its carrier/operator and/or a third party) to have calls and/or messages inbound to the client device 202 forwarded to another device instead of, or in addition to (similar to three-way calling), the PSS client device 202. The call/message forwarding/notifying service 204f may enable the PSS client device 202 to configure itself, a peer device, and/or a network service (e.g., provided by its carrier/operator and/or a third party) to accept calls forwarded from another PS client device instead of, or in addition to (similar to three-way calling), the other PSS client device. The call/message forwarding/notifying service 204f may enable the PSS client device 202 to configure itself, a peer device, and/or a network service (e.g., provided by its carrier/operator and/or a third party) to send and receive notifications of messages and/or calls sent to the client device 202 to another device. For example, each of two PSS client devices 202a and 202b may be enabled, via their respective call/message forwarding/notifying services 204f, such that, when a call is incoming to the device 202a a notification will also flash on a device 202b until the call is answered on device 202a, the caller hangs up, or until a user of device 202b picks up device 202b and (using an interface provided by the call/message forwarding/notifying service 204f) selects to have the call forwarded to device 202b. When notifications/forwarding is active may be based on any number of user-defined triggers and the type of notifications/forwarding may be based on any number of user-defined criteria. Example events which may be selected to activate call forwarding/notifications include: detection of low battery in a PSS client device, indication that a PSS client device has been lost/stolen/left behind (e.g., sensor outputs and/or usage data indicating the client device has not moved or been used for a determined period of time), an indication that functional and cosmetic testing of a PSS client device is in progress and has rendered it currently unable to receive calls/messages, an test result indicating a failure that renders the device unable to receive calls/message, and/or any other indication that a device's user/owner is currently unable to receive a call/message on that device). Forwarding/notifications may be deactivated by user intervention and/or when the triggering condition is no longer present. The forwarding/notifications may use an actual phone number or fixed IP address, if the device has one, or to a virtual phone number or proxy IP address (e.g., using Skype, Google Talk, and/or some similar service). Forwarding or notifications may be via a peer-to-peer connection (e.g., Bluetooth) and may be broadcast (e.g., to enable a lost phone to notify nearby devices that a call or message is incoming and/or to help locate the phone).

The device-specific and/or user-specific targeted offerings function may comprise analyzing data generated by one or more of: the usage monitoring service 204a, the configuration/environment data and user data collection service 204b, the backup and clone/restore support service 204c, device status collection/reporting service 204d, the failure work-around server 204h, and/or function and cosmetic testing service 204e to determine offerings to be served to the PSS client device 202 and/or served to another client device managed by the PSS client device 202. An offering may be, for example, a firm offer to buy or sell, a referral or recommendation (e.g., a hyperlink that may generate commissions if clicked-through) The offerings may be selected from pre-existing offerings provided by affiliates and/or custom offerings may be generated by the post-sale support system based on data gathered from both PSS client devices and affiliates. Such custom offerings may comprise aggregate info from multiple affiliates combined into a single offering for upgrading, replacing, repairing, accessorizing, etc. PSS client devices. In this manner, the PSS system may facilitate a flow or chain of transactions that conventionally would require the PSS client device user to “shop around” and contact multiple affiliates separately (e.g., have device repaired by a repair affiliate, then sell it to another PSS user, and then use the money to purchase a different phone from a marketplace affiliate). In one configuration, the client device may aggregate and analyze the data and then send a request for an offering that meets specific criteria (i.e., the client device may pull offerings). In another configuration, the data may be aggregated and analyzed on a server such as the server 108 and the server may push offerings to PSS client device.

Example offerings enabled that may be served to a client device by the PSS system: based on hardware usage/wear-and-tear data indicating that the CPU of the client device is often driven very hard for performing graphics processing operations, an offer to sell or referral to a seller of a replacement client device that has a dedicated GPU; based on general device data indicating a current service plan for the client device, and based on activity logs indicating that the client device uses all of its voice minutes each month but very little of its data allotment, an offer to sell or referral to a seller of a service plan with more talk time and less data (e.g., from a different carrier willing to buy out the client device's current contract); based on test data indicating that the case of the client device is cracked, an offer to sell or referral to purchase a replacement device (either the same device as the current device or a different device better suited to the usage patterns of the user); based on test data indicating that the battery currently only holds 50% of its original maximum charge, an offer to sell or referral to a seller of a new device or replacement battery; based on test data that there is a small crack in the screen of the client device, an offer to sell or referral to a seller of a repair kit for that particular device; based on usage data that a particular port (e.g., USB) of the device is very heavily used for connecting the device to external equipment, an offer to sell or referral to a seller of for a device with an additional port (e.g., HDMI); based on usage and/or test data that memory of the device is failing (e.g., 30% of the sectors have failed), an offer to sell or referral to a seller of a replacement memory compatible with the device may be served to the device; based on a determination that the device has been restored many times, an offer to sell or referral to a seller of for a malware removal tool may be served; based upon usage data indicating that the device spends a lot of time in a location where it has poor service, an offer to sell or referral to a seller of for a device and/or carrier that provides better service in that location may served to the device; based on a software and/or hardware failure work-around currently being used, an offer to sell the failed hardware being worked-around, a software patch to fix the software being worked-around, or the like.

The failure work-around service 204h enables the PSS client device 202 to identify functions that are unavailable due to failure of a software and/or hardware component of the PSS client device 202, and to load work-around code that provides an alternative method of performing the functions. The work-around code may, for example, be stored in the device during manufacture (e.g., it may be an operating system component) and/or the service 204h may download the code on demand in response to detecting the failure. In the case of a hardware failure, the work-around code may configure the work-around hardware as appropriate for the particular failure and then reroute signal paths, resources, etc. to bring the work-around hardware 206k into use.

FIG. 2B depicts an example server or servers of a PSS provider. The server(s) 220 comprise(s) software 222 running on hardware 224. The hardware 224 comprises a housing/enclosure, wired and/or wireless communications interfaces circuitry 224b. The hardware may comprise processing circuitry 224c (e.g., one or more CPU cores, one or more coprocessors, one or more bus interfaces, and/or the like). The hardware 206 may comprise memory 224a (e.g., SRAM, DRAM, ROM, hard-disk, Flash, and/or the like) which may store data organized into one or more tables, databases, files, and/or the like.

The data stored in the memory of the server(s) 224 may be collected by client devices such as the device 202 of FIG. 2A. For each client device and/or each account, data stored in memory of the server(s) 224 may comprise any of the data types described above with reference to FIG. 2A. Data stored in the memory of the server(s) 224 may be encrypted (fully or partially) and/or anonymized (fully and/or partially).

For some users and/or PSS client devices, the server(s) 220 (i.e., the software 222 running on the hardware 224) provides full service functionality (i.e., performs most or all of the services of the PSS system described herein (e.g., testing, valuation, restore/cloning/backup, targeted offerings, etc.)) in combination with client devices that operate as “thin clients” and interact with the PSS server(s) 220 via a browser. For other users and/or PSS client devices, the client devices may provide most or all of the services described herein (e.g., via native PSS apps installed on the client devices) while the server(s) 220 has/have limited access to confidential information and do(es) little more than manage user account setup and login plus assisting with peer-to-peer communication exchanges or setup/tear-down of call/message forwarding/notification (if needed). For “thin” client devices which rely on the PSS server(s) to perform/provide most or all of the PSS services, such devices may visit the web service at its user's leisure. When it does visit, it may receive program code functionality on the fly via Java, an add-on or the like to do “heavy” or “light” lifting. But if it doesn't visit, it doesn't receive some or all of the PSS services. If the device has a native PSS app installed, on the other hand, the app may be persistent while the device is powered up, for example. Being persistent, it may provide some or all of the PSS services such as ongoing functional and cosmetic testing, usage monitoring, status reporting, and valuation based on regularly scheduled testing and monitoring, which may not occur possible with a “thin” client which may have its usage monitored, functionality and appearance tested, valuation calculated, etc. only when visiting the web service via its web browser.

Regardless of whether the client devices interact via browser or native App, the amount of functionality/services performed by the PSS server(s) may be a little or a lot. This balance of the functions/services being carried out via the browser code/add-on or via the native App. For example, for a first user's device that is seemingly fully functional, the PSS server(s) 220 may direct a step-by-step and detailed testing process to be conducted by the first device, (i.e., server heavy and thin client). For a second user's smartphone which seems to have problems, the second user may tether the smartphone to their personal computer (PC). The PC may interact with both the server(s) 220 (either performing the bulk of the work or acting as a thin client while the PSS server(s) 220 do the bulk of the work) and to the smartphone to carry out smartphone testing. This may involve delivering power via a tether, determining whether the device boots up (e.g., if the problem is the power supply, the device may not boot up when powered by the power supply), booting the smartphone (if possible), and causing the smartphone to perform at least one of (i) directly interact with the PSS server to download and execute a testing App; (ii) service testing commands delivered over the tether that originate from the browser, from App code running on the PC, and/or from the PSS service; and/or (iii) receive via the tether and execute testing code that originates from PSS service. If testing App code (e.g., previously downloaded from PSS server(s) 220) happen to be present on the smartphone, it may be launched upon the tethered power boot too and carry out whatever functionality has been defined in that code. And, for any of these approaches, the PC may be performing such assistance either per PC App direction or in response to visiting the PSS server(s) 220 using a web browser. Thus, if a client device has a problem that prevents it from accessing the web, a browser-based implementation may not enable the PSS system to test/troubleshoot that device. But if that device already had a PSS app downloaded before its problems began, the device may still be able to run the App. If that app requires substantial direction from the PSS server to operate, it may be of little more help than the browser-based implementation. But if the App has capabilities of performing substantial PSS functions/services, the device may be able to perform more extensive testing/troubleshooting/restore/etc.

Services/functions performed by the server(s) 220 may include usage monitoring service 222a, configuration service 222b, replacement and backup support service 222c, device and user status support service 222d, test and monitoring control and management service 222d, call setup and tear down support service 222f, targeted advertising service 222g, payment management/support service 222h, administrator interface service 222i, affiliate interface service 222j, and work-around code delivery service 222k.

Through the call setup and tear down support service 222f, the service 220 may facilitate peer-to-peer (between two PSS client devices) connections between client devices. For example, the PSS server(s) 220 may register IP addresses and/or telephone numbers for client devices and may provide those registered numbers/addresses to client for those devices to use without further intervention by the PSS server(s) 220 and/or may serve as a middleman/router for communications between the client devices. To support services described herein, the data and functionality for making decisions related thereto (or establishing valuations and service estimates) can be passed to the underlying PSS client device for its own private determinations. Of course, with such data being made available with customer's consent, such analysis can take place on the server(s) 220. Another alternative is for a PSS client device to generalize the data before passing to the server(s) 220. Still another alternative is to seek offerings, referrals, valuations, etc., anonymously (without login or identity info being passed). In an example implementation, the server(s) 220 handle(s) one or more of: status exchanges and IP address registration support, pricing info uploads or direct database input relating to affiliate (e.g., recycling affiliate(s), repair affiliate(s), carrier affiliate(s), marketplace affiliate(s)) valuations, management of price assessment based on info from affiliates to automatically generate valuations, offerings, repair costs, etc.

The server(s) 220 may provide an interface 224j for interactions with affiliate servers. The service 222j may operate as a host that provides an application programming interface (API) via which an affiliate server/device (e.g., 260 of FIG. 2D) can retrieve data from the server(s) 220 and/or post data to the server(s) 220. Additionally, or alternatively, the service 222j may operate as a client that uses an API provided by affiliate server(s)/device(s) (e.g., 260 of FIG. 2D) to retrieve data from the affiliate server(s) and/or post data to the affiliate server(s). In one example implementation, the server(s) 220 may interact with affiliates using email (with or without human administrator intervention). Regardless of how the data is exchanged between the server(s) 220 and the affiliate server(s), the data exchanged may include, for example, pertinent info needed for shipping of devices to/from affiliates and payment to/from affiliates and/or payments to/from customers (e.g., Order number, Customer Identifier, shipping tracking number, Shipping Address, Billing Info, Phone Info, Price Quote, Quality Calculation, Test Results, Customer Comments, Quoted Expected Date of Completion). The data exchanged may enable the post-sales support provider and/or affiliate(s) to comment and reconcile actual receipts, actual consideration paid/promised, etc. The data exchanged may enable the post-sales support provider and/or affiliate(s) to enable updating of pricing schedules and information. The data exchanged may include affiliate offerings along with metadata on when and how the offerings should be served by the post-sale support provider.

The service 222i may provide an interface for interactions with PSS administers/customer representatives. The service 222i may operate as a host that provides an API via which administrators/representatives (e.g., using the client device 240 of FIG. 2C) can perform peruse, delete, modify, etc. entries for a variety of purposes such as providing technical support to PSS users, for providing customer/order support to PSS users (e.g., reconciling/providing status on shipments, payments, etc.) and/or for providing support to affiliates (e.g., reconciling/providing status on shipments, payments, etc.).

FIG. 2C depicts an example administrator/representative device of a post-sale support provider. The device comprises software 242 running on hardware 244. The hardware 244 comprises a housing/enclosure, a display 244c (e.g., LCD, OLED, e-ink, or the like), physical buttons/keys 244d, a camera 244e, a microphone 244f, speakers 244g, and an input device 244h (e.g., touchpad, trackball, joystick, touchscreen, and/or the like) for navigating among elements displayed on the display. The hardware 244 may comprise wired and/or wireless communications interface circuitry 244a (e.g., Wi-Fi network adaptor, Bluetooth network adaptor, wired Ethernet network adaptor, cellular network adaptor, and/or the like). The hardware 244 may comprise processing circuitry 244b (e.g., one or more CPU cores, one or more one or more coprocessors, one or more bus interfaces, and/or the like). The hardware 244 may comprise memory 244i (e.g., SRAM, DRAM, ROM, hard-disk, Flash, and/or the like) which may store data organized into one or more tables, databases, files, and/or the like.

The administrator/representative device 240 may provide a service 242a (e.g., browser based and/or a native application) for interacting with the PSS server(s) 220 of FIG. 2B. The service 242a may operate as a client that uses an API provided by the PSS server(s) 220 for retrieving data from, and/or putting data to, the server(s) 220. The administrator/representative device 240 may provide a service 242b (e.g., browser based and/or a native application) for interacting with the affiliate server(s) 260 of FIG. 2D. The service 242b may operate as a client that uses an API provided by the affiliate server(s) 220 to retrieve data from the affiliate server(s) and/or store data to the affiliate server(s).

FIG. 2D depicts example server(s)/device(s) of an affiliate of a post-sales support provider. The hardware 264 comprises a housing/enclosure, wired and/or wireless communications interfaces circuitry 264b. The hardware 264 may comprise processing circuitry 264c (e.g., one or more CPU cores, one or more coprocessors, one or more bus interfaces, and/or the like). The hardware 266 may comprise memory 264a (e.g., SRAM, DRAM, ROM, hard-disk, Flash, and/or the like) which may store data organized into one or more tables, databases, files, and/or the like.

The server(s)/device(s) 260 may provide a service 262b for interactions with PSS servers. The service 262b may operate as a host that provides an application programming interface (API) via which PSS server(s) (e.g., 220 of FIG. 2B) can retrieve data from the server(s) 260 and/or post data to the server(s) 260. Additionally, or alternatively, the service 262b may operate as a client that uses an API provided by PSS servers (e.g., 220 of FIG. 2B) to retrieve data from the PSS server(s) and/or post data to the PSS server(s). In one example implementation, the server(s) 260 may interact with the post-sale support system using email (with or without human administrator intervention). Regardless of how the data is exchanged between the server(s) 260 and the PSS server(s), the data exchanged may include, for example, pertinent info needed for shipping of devices to/from affiliates and payment to/from affiliates and/or payments to/from customers (e.g., Order number, Customer Identifier, shipping tracking number, Shipping Address, Billing Info, Phone Info, Price Quote, Quality Calculation, Test Results, Customer Comments, Quoted Expected Date of Completion). The data exchanged may enable the post-sales support provider and/or affiliate(s) to comment and reconcile actual receipts, actual consideration paid/promised, etc. The data exchanged may enable the post-sales support provider and/or affiliate(s) to enable updating of pricing schedules and information. The data exchanged may include affiliate offerings along with metadata on when and how the offers should be served by the post-sale support provider.

The server(s)/device(s) 260 may provide a service 262a for interactions with affiliate administers/representatives. The service 262a may operate as a host that provides an API via which administrators/representatives (e.g., using the client device 280 of FIG. 2E) can perform peruse, delete, modify, etc. entries for a variety of purposes such as providing technical support to affiliate customers, for providing customer/order support to affiliate customers (e.g., reconciling/providing status on shipments, payments, etc.) and/or for providing support to PSS representatives (e.g., reconciling/providing status on shipments, payments, etc.).

FIG. 2E depicts an example administrator/representative device of PSS affiliate. The device 280 comprises software 282 running on hardware 284. The hardware 284 comprises a housing/enclosure, a display 284c (e.g., LCD, OLED, e-ink, or the like), physical buttons/keys 284d, a camera 284e, a microphone 284f, speakers 284g, and an input device 284h (e.g., touchpad, trackball, joystick, touchscreen, and/or the like) for navigating among elements displayed on the display. The hardware 284 may comprise wired and/or wireless communications interface circuitry 284a (e.g., Wi-Fi network adaptor, Bluetooth network adaptor, wired Ethernet network adaptor, cellular network adaptor, and/or the like). The hardware 244 may comprise processing circuitry 284b (e.g., one or more CPU cores, one or more one or more coprocessors, one or more bus interfaces, and/or the like). The hardware 284 may comprise memory 284i (e.g., SRAM, DRAM, ROM, hard-disk, Flash, and/or the like) which may store data organized into one or more tables, databases, files, and/or the like.

The affiliate device 240 may provide a service 282a (e.g., browser based and/or a native application) for interacting with the affiliate server(s)/device(s) 260 of FIG. 2D. The service 282a may operate as a client that uses an API provided by the affiliate server(s)/device(s) 260 for retrieving data from, and/or putting data to, the server(s)/ device(s) 260. The administrator/representative device(s) 280 may provide a service 282b (e.g., browser based and/or a native application) for interacting with the PSS server(s) 220 of FIG. 2B. The service 282b may operate as a client that uses an API provided by the PSS server(s) 220 to retrieve data from the PSS server(s) and/or store data to the PSS server(s).

FIGS. 3A and 3B depicts an example graphical user interface (GUI) presented by a post-sales support system to a client of the post-sales support system. The GUI may be HTTP/HTML-based and served by PSS server 220 to client device(s) via browser and/or use a proprietary API(s) and/or protocols native app running on the client device(s). Via the GUI, customer/device owners may signup and sign-in with password/user name.

The example GUI comprises a general element/window/frame 302 and a targeted offerings element/window/frame 304. In the example shown, the element/window/frame 302 comprising a “home” tab/view 302a, a “my devices” tab/view 302b, a “backup” tab/view 302c, a “testing” tab/view 302d, a “repair” tab/view 302e, a “recycling” tab/view 302f, a “marketplace” tab/view 302g, and a “contact” tab/view 302h.

The “home” tab/view 302a may, for example, present a high-level summary of the more detailed info that can be found in the other tabs/views. Example content of the home tab/view is shown in FIG. 3B, where it lists each device on the account, the user assigned to each device, a description of the device, a status of communications between the device and the post-sales support service, an indication of the overall condition (or “health”) of the device, whether the device is currently set to have calls or messages forwarded or replicated onto other devices, an estimate of the value each device would fetch from a recycler, and an estimate of the price to fix each device that has a known problem (e.g., through results of testing provided by the post-sale support service).

The “my devices” tab/view 302b may list and provide the status of the various devices associated with the user's account. The “backup” tab/view 302c may provide an interface for configuring what information to backup from various devices on the account and when to back them up. The “testing” tab/view 302d may provide an interface for performing tests of one or more devices on the account (for valuation and/or for troubleshooting). The “repair” tab/view 302e may provide an interface for finding a repair facility or service, and pricing desired repairs. The “recycling” tab/view 302f may provide an interface for finding a device recycling service and pricing the amount that various devices on the account would fetch from various recycling services. The “marketplace” tab/view 302g may provide an interface for buying, selling, and listing devices for sale or trade. The “contact” tab/view 302h may provide an interface for obtaining customer support for the post-sales support service.

The element/window/view 304 presents targeted offerings from affiliates, such as those described above. As discussed above, the targeted offerings may be targeted based on data generated by/during the PSS usage monitoring service, the cosmetic and functional testing service, and the backup and clone/restore service. In the example shown, there are four separate views for offerings for accessories, devices, term service contracts, and prepaid service contracts.

The GUI may present offerings for services/features of the PSS system, such as those services/features described herein. The GUI may provide a device management view where all devices and associated status and valuations can be reviewed, deleted, modified (may be limited somewhat if server does not store certain info) etc. Such status may indicate, for example, any ongoing or scheduled testing of any of the devices; any ongoing or scheduled backup of any of the devices; valuation(s) (for trade-in, recycling, resale, and/or the like) of any of the devices based on most-recent usage data and/or testing data for the device(s); cost to repair any of the devices based on most recent testing data for the device(s). The GUI may provide GPS map interaction that displays the current or last reported location of each of the devices. The GUI may provide additional or other features. In other words, the GUI can provide full customer support that extends to provide/facilitate any or all of the PSS services/functions described herein.

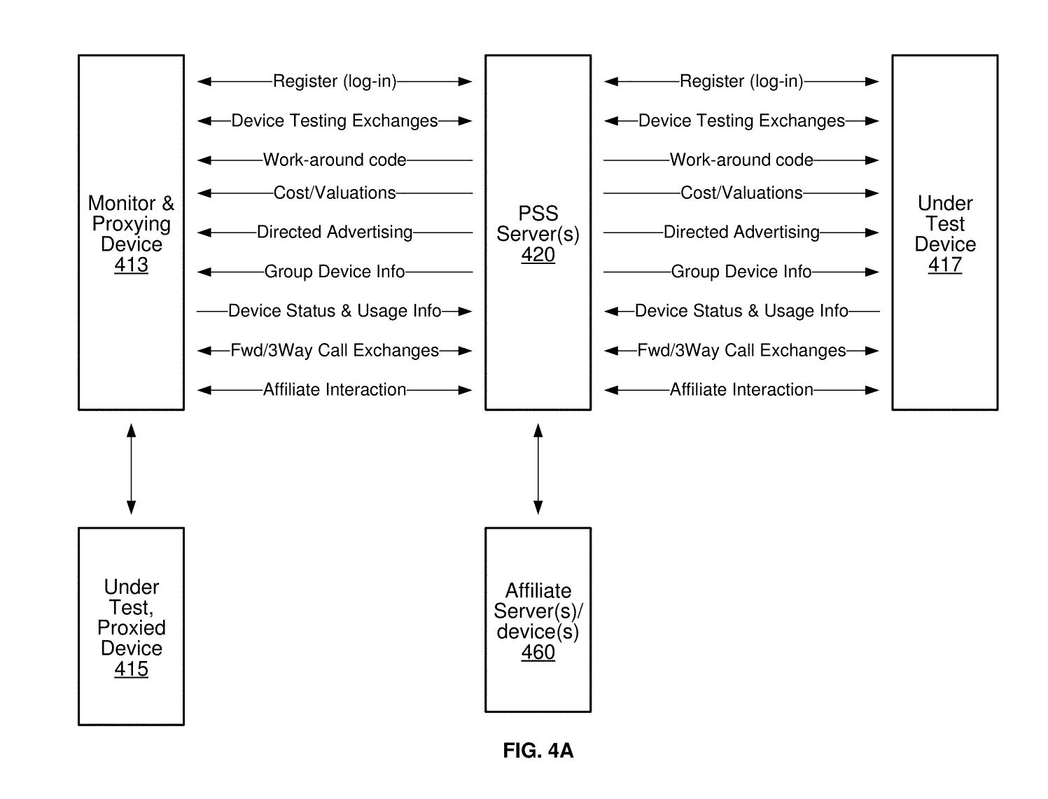

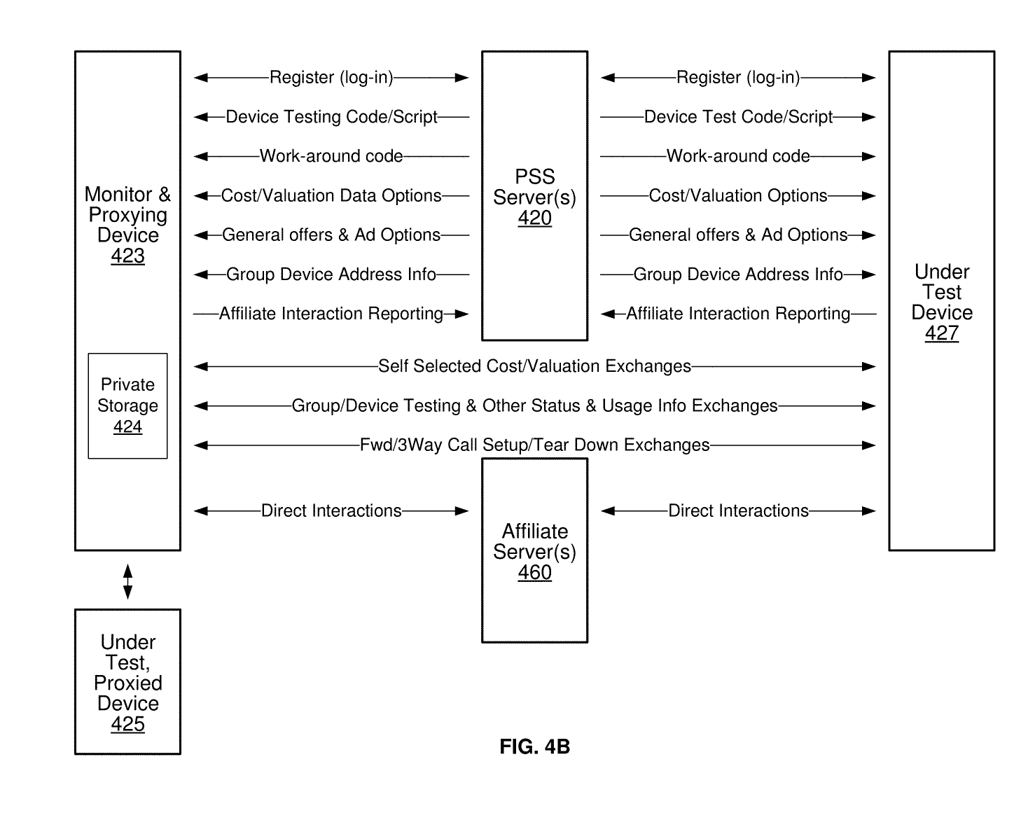

FIGS. 4A and 4B illustrate example communication topologies/configurations of a PSS system. In FIG. 4A, the PSS client device 417 (e.g., an example implementation of client device 202) is functional enough to interact directly with the PSS server(s) 420 (an example implementation of PSS server(s) 220) such that functional and cosmetic testing, delivery of work-around code, and/or other PSS services can be performed on/provided to the client device 417. Client device 415, on the other hand, is not sufficiently functional to connect to the PSS server(s) 420. Accordingly, device 415 is tethered to the client device 413 and the client device 413 is operating in a managing and monitoring mode to control/direct testing of the device 415, monitor the device 415, report on the status of device 415, provide software and/or hardware to be used as a work-around for failed software and/or hardware in the device 415, etc. Also in FIG. 4A, the PSS server(s) 220 function as an intermediary between the affiliate server(s)/device(s) 460 (an example implementation of server(s)/device(s) 260) and the client devices 413, 415, and 417. Thus, in FIG. 4A, the PSS server(s) 220 may be a highly trusted device relied on to shield client devices from each other (e.g., client devices of one user shielded from client devices of another user) and from the affiliate device(s) 460.

In FIG. 4B, on the other hand, client devices can interact directly with each other (e.g., after obtaining routing/address information from the PSS server(s) 420) and/or directly with affiliate server(s)/device(s) 460. In this configuration/topology, the PSS server(s) 420 are relied on less. This may reduce the chance of the server(s) 420 becoming a bottle neck and may be preferred where client devices don't want a single entity to have so much control over device interactions and/or client device data.

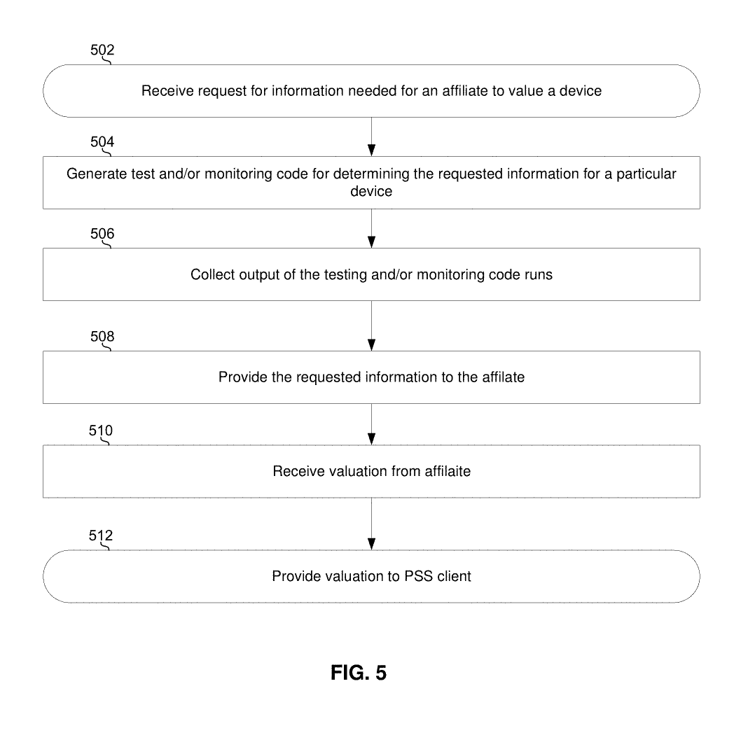

FIG. 5 is a flowchart illustrating testing of a client device in post-sale support system to support valuation based on the test results.

In block 502, a PSS server 220 receives, from an affiliate, a set of guidelines that indicate the information about a particular device that is needed in order to determine a value that the affiliate would pay for the device. For example, one affiliate for a given device model may want to collect a series of data associated with usage, defect, ongoing and one time test data, while others seek only an overall quality number constructed via an additive summary. Based on such feedback, an affiliate can determine either how much value remains in the current device, taking into consideration resale as-is status and/or repair/refurbishing costs.

In block 504, the PSS server 220 generates testing and/or monitoring code that is tailored to extract the requested information for a particular client device. Such code can be embodied in an App download, Java or other browser script or browser add-on code. Such code can be loaded on the client device to be tested and/or monitored (e.g., device under test 417 of FIG. 4A) or loaded on a client's testing device which will itself test the tested device (e.g., monitoring and proxying device 413 of FIG. 4A). In addition, testing code may run on a server (e.g., 220) which interacts via a communication network to direct testing of a tested device (such as a smartphone). Lastly, such code may be distributed across any plurality of such devices as might prove beneficial under the testing circumstances and configuration.

In block 506, the PSS server 220 collects the output of the testing and/or monitoring code. Execution of the test and/or monitoring code can comprise a one-time test or an ongoing test which also catalogs (mis)usage and detects defects/failures. Because some problems are periodic and intermittent, ongoing testing may offer a more trustworthy device status/quality determination. This can result in a higher quality valuation overall. The collected output may include, for example: (i) recent time stamped test data; (ii) recent time stamped status & usage data; (iii) geographic data; (iv) visual appearance data (e.g., i.e., pictures of the device); (v) model number & configuration data; and (vi) peripheral/component/casing visual appearance/model data;

In block 508, the PSS server communicates the requested information to the affiliate.

In block 510, the affiliate responds with a current value ($) or offer to purchase number. The affiliate may use the information received from the PSS service along with other information such as: promotional trade-in/upgrade/buy-back data; recycler's/reseller's current values; and repair bill data (from resellers & from independent service shop affiliates). The affiliate may then calculate the valuation including “good estimate till dates” and “estimates based on <date> data” which may change/can be updated (yes/no), or may be locked in, etc.

In block 512, the valuation is presented to the user (e.g., via the GUI of FIGS. 3A and 3B)

In another implementation, instead of requiring involvement of the affiliate server at this level (i,e., communications between the PSS system and the affiliate for individual valuations), the affiliate may merely provide database information that associates each model and test and/or monitoring information against current value. Once received, the PSS server and/or client device, and/or a managing or monitoring client device can provide the current value information for that affiliate on the fly as needed. In addition, with ongoing test information being readily available, the PSS server, a managing and monitoring client device, and/or a client device under test can periodically gather such data or quality summaries and use it to select and deliver the current value so that even a continuously displayed valuation number can be presented to the user (e.g., via a corner/border screen icon). Such icon can be on both or either of the testing device or tested device.

Further automation of this process can be found with an affiliate that desires to control the number of devices purchased within a particular quality range category. For example, a current affiliate may desire only 100 high-quality and 50 medium-quality devices. Once a sales limit has been reached, such affiliate will not participate in valuation offerings. Other quality devices or those beyond the 100 and 50 may be valued by others. Affiliates may also involve a user desiring to buy even only one high quality device. They may “bid” for one top quality device at a committed pricing level that may be accepted by a current owner. An interface for carrying out and managing these commitments to buy may be provided by the PSS server. They can also be handled over phone or email through manual PSS staff interactions with the PSS server.

In an example implementation, an owner of a recently-tested client device may peruse all or just the top offers from affiliates. Such a device owner agreeing to one of the offers may trigger a contract requiring the owner to package their device, cables, manuals and mail/overnight to the “winning” affiliate. The moneys from the buyer/affiliate can be collected by the PSS system and held till the delivery is received. It could also be collected only after receipt. The PSS system can retain a portion of the moneys for services rendered, or otherwise charge monthly or periodically in an independent manner. Moneys received by a prior owner of a sold device can be routed to a PayPal, Bank or Credit Card account, for example. Or, it might be available for making purchases through special offers made via the PSS server. For example, a special offer might be for the current owner to receive a “trade-in” credit for an Amazon store phone upgrade where the SIM can be reused. Upon the current owner agreeing, the PSS server identifies the “mail address” of their phone along with a tracking number. This can be printed off and placed in the envelope/box/container along with their current phone. The address being of a first affiliate that committed to a purchase price via a transfer to a PayPal holding account of the PSS service company. Upon receipt, the affiliate interacts with the PSS to log their receipt and quality confirmation. This may automatically trigger completion or prompting of the trade-in event. The client may have already committed the difference amount to the PayPal holding account. If so, the transaction can be finalized with Amazon via their storefront interface. Otherwise, the user can be emailed or otherwise prompted to revisit the PSS site to finalize the trade-in. While visiting, the user can change their mind and collect their recycle value received or buy something else.

On trade in, replacement or cloning requests, the PSS server (with or without client testing device assistance) can manage copy over configuration/environment data. This may involve an intermediate storage of such information before a current device is sent in for repair or recycling. Such intermediate storage may be maintained over time via multiple instances that are all maintained for fallback purposes—such as (i) resetting to a prior known or assumed good state, (ii) being ready for a full device failure/breakdown, and (iii) to support cloning on the fly without having to have direct and current access to the cloned device.

A similar process to FIG. 5 can be used for determining a cost to repair/refurbish a client device.

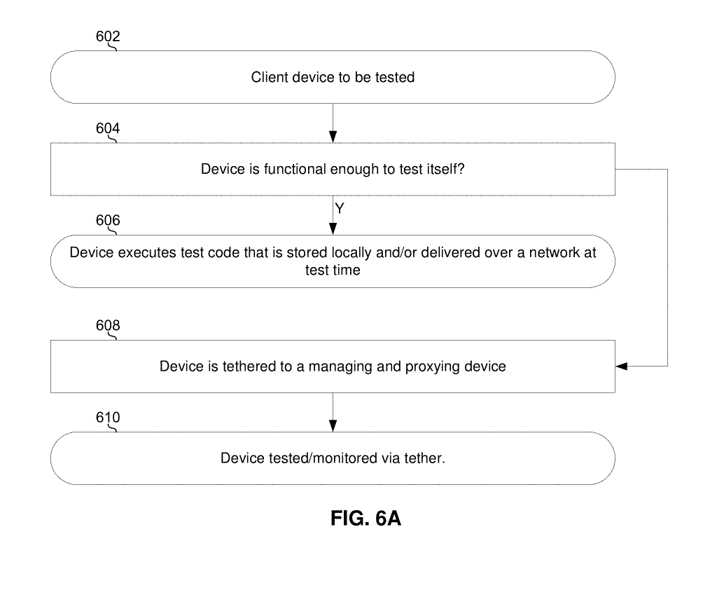

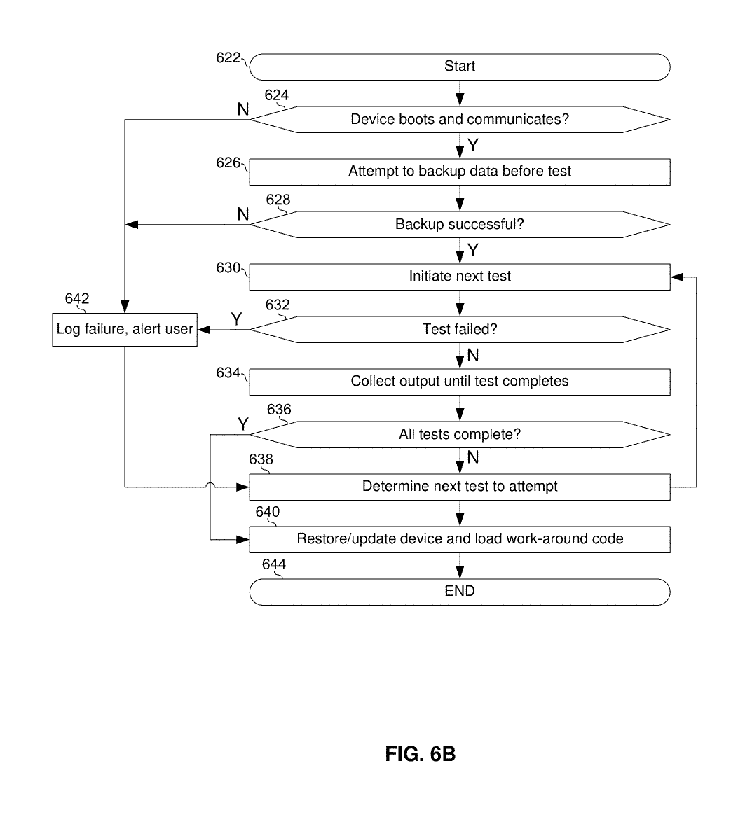

FIG. 6A is a flowchart illustrating testing of a client device in a post-sale support system. The process begins in block 602 in which testing of a client device is triggered. The trigger may be an event or condition occurring or being detected by the client device or a device that is managing and monitoring the client device. The event may be, for example, a request from an owner of the client device clicking a “get valuation now” button in the GUI. In block 604, it is determined whether the client device is sufficiently functional to test itself (e.g., execute test code). In a configuration where the test code is already downloaded, such sufficient functionality may not include ability to communicate over a network. In a configuration where the test code is delivered immediate before and/or during testing, such sufficient functionality may include the ability to communicate with the PSS server or a monitoring and managing device over a network. If the client device to be tested is sufficiently functional, then in block 606 the device executes test code that was either previously downloaded and/or is downloaded at/during test time. Returning to block 604, if the client device to be tested is not sufficiently functional, then in block 608 it is tethered (e.g., via USB or NFC) to a monitoring and proxying device and then, in block 610, the monitoring and proxying device controls the testing via the tether. Thus, testing of a fully functional device may comprise running test code on the client device itself while the client device operates on its own power supply or may comprise testing directed by test code running on a managing device (such as a tablet or pc that tests a phone) or on the PSS server. Alternatively, the testing device may not be operating correctly or seems completely dysfunctional (e.g., won't power up or won't boot up), and thus may require assistance of the client's managing and proxying device via a power delivery and communication interface such as USB. Wireless power interfaces and wireless communication interfaces (combined or pluralities) may also be used. Testing through such interface(s) may require bypassing a main operating system and main/primary processing of the client device to be tested, as needed to directly test particular hardware components of the client device to be tested. Test data might comprise “one time test data”—data collected upon demand at the initiation of a single test. It may also include such data and/or all prior over-time collections of such test data.

FIG. 6B is another flowchart illustrating testing of a client device in a post-sale support system. The process begins in block 622.

In block 624 a testing device (e.g., PSS server 420 communicating or a monitoring and proxying device 413) determines whether the device to be tested successfully boots up and is capable of communicating (e.g., over a network link or a tether). If the device does not boot or does not successfully communicate, the process advances to block 642.

Returning to block 624, if the device under test successfully boots and communicates, then the process advances to block 626. In block 626, in which it is attempted to backup configuration, user data, etc. before performing the testing such that the state of the device can be restored upon completion of the testing. In block 628, if backup fails then the process proceeds to block 642. Returning to block 628, if the backup is successful then the process advances to block 630. In block 630, a test that is next in line to be executed is initiated. This may comprise, for example, downloading a piece of test code to the device under test, or triggering the device under test to load a piece of test code from it memory, and then triggering the device under test to begin execution of the piece of test code. In block 634, output from the test code is collected as part of the test results. In block 636, the testing device determines whether all desired tests (or possible tests, where the device under test is semi-functional) have been performed. If not, the process advances to block 638.

In block 638, the testing device determines which test to perform next. Which test is selected to be performed next may be based on any failures that may have been logged during a pass through block 642. For example, where the device failed to boot in block 624, the testing device may decide the next test to be a low-level hardware test (e.g., battery test, memory scan, CPU test or other direct testing of hardware via a tether that may be made possible by work-around hardware that provides access to such circuits via a tether (e.g., providing a JTAG or similar interface over a USB or NFC tether). As another example, where the device failed to successfully backup, a test that does not alter the configuration of the device under test and does not put user data at risk of corruption may be selected as the next test to be performed. As another example, where an earlier test indicated a failure of a particular hardware component, the testing device may skip any further tests of that hardware component or, on the other hand, may do the opposite and select another test of that hardware component in an attempt to get more specific info about the type of failure. Which test is selected in block 638 may also be based on results of previous tests. For example, where a battery test performed after a failure to boot indicates that the battery was uncharged, then in block 638 the testing device may select a test to see if the device under test now successfully boots.

Returning to block 636, if all tests to be performed are complete, then the process advances to block 640. In block 640, after completion of testing, the device is restored to its pre-testing state, possibly with software updates and/or work-around code installed based on problems detected during testing. In block 644, the process is complete.

Returning to block 642, failures during the testing process are logged as part of the test results. In some instances, where a failure has been detected, block 642 may comprise generating an alert to the testing device and/or user. For example, where the device fails to boot block 624, block 642 may prompt a user to press a test trigger button (e.g., a combination of the input/output buttons or a dedicated button concealed in a battery compartment, for example). As another example, where backup failed in block 628, block 642 may alert the user that settings and/or data may be lost and give the option of aborting the testing.

Testing may include standard functional testing and delivery of test results, general device info (e.g., make, model, etc.), and configuration/environment data (possibly over a power-delivering tether in the even the device under test is not sufficiently functional to communicate over a network). The testing may also attempt to identify mechanical (including cosmetic and/or structural) defects/damage.

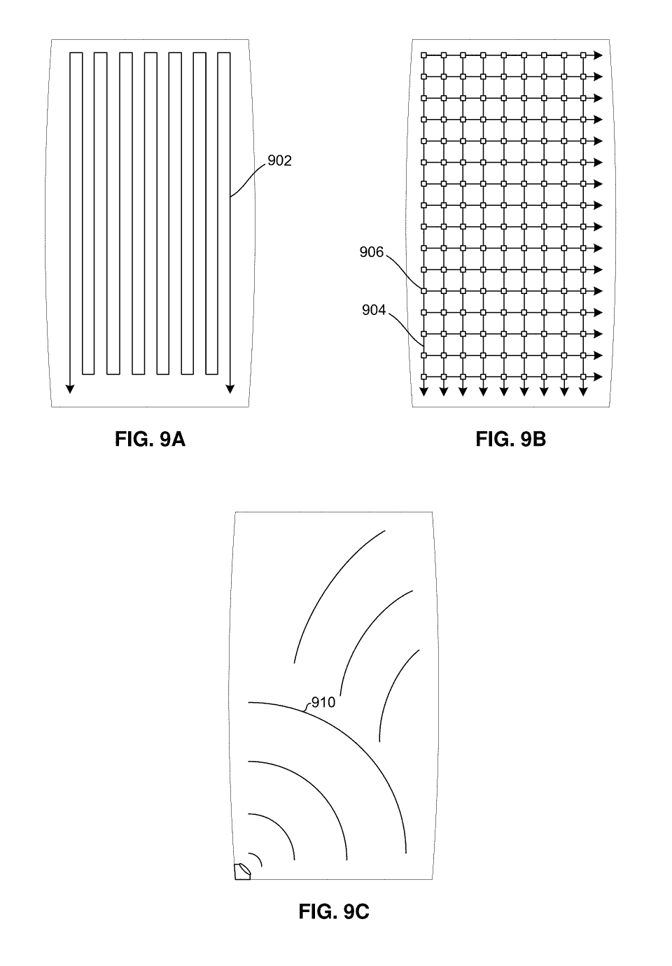

Cracks in a screen and/or housing of the client device may be tested for through electrically probing conductors embedded or on a surface of the device's housing and/or touchscreen. If a crack is present, conductivity between two points of the conductor(s) may be broken. In an example implementation, a single conductor, such as 902 shown in FIG. 9A, may enable detection of a crack somewhere on the housing. In another example implementation, such as shown in FIG. 9B, the conductors 904 may be row and column addressed using thin film transistors 906 such that a more precise location of any detected cracks may be determined. Similarly, probing the integrity of soldered wires may be used to determine whether the device's housing has been removed or otherwise tampered with.

Failed pixels in the screen of the client device may be tested for by presenting different colors/images and asking the user to identify/locate the objects. For example, one or more pixels may be set to blue in an otherwise black field and the user may be instructed to tap the blue pixel(s). Failure of the user to tap the pixels) may indicate that the blue pixel(s) have failed. Similarly, the user may be instructed to scroll through a sequence of images which test various aspects of the display and take a corresponding sequence of pictures of the screen (e.g., using a front-facing camera of the device and a mirror) such that bad pixels etc. can be seen in the captured pictures. The images may be unique to each testing sequence and/or tested device to ensure that the screen being captured in the pictures is the screen of the device being tested and not a spoof. Detection of failed pixels may trigger work-arounds similar to those described below with reference to FIG. 13A to minimize the impact of the failed pixels on user experience.

Display/touchscreen performance can also be determine based on the usage monitoring data. For example, the screen always being set to max brightness may indicate that it is losing brightness over time. Similarly, speaker performance can be determined based on historical volume settings (e.g., the volume always low may indicate that the speaker is blown and that the user does not want to hear hissing and popping from a blown speaker). Blown speakers or otherwise poor performing speakers can also be detected via loopback though a microphone. By detecting that a phone is stationary and via (GPS) locationing and time of day and date, it can be concluding that the phone is likely sitting on a home desk at night. Then, the speakers can be exercised through a frequency range with microphone picking up the speaker output. From this, poor performance of the microphone and/or speakers can be determined to be likely. A fix might be to suggest that the user clean holes in a grill, or might increase base speaker or microphone amplification with attention to equalizing frequency response performance.

Cracks in a screen and/or housing of the client device may be tested for through piezo emission/reflection pickup analysis (position along edges of screen and inject surface acoustic waves), as shown in FIG. 9C, for example. That is, to detect abnormalities in the housing or display, one or more sources of acoustic waves 910 (e.g., one or more piezo elements) may inject waves periodically and then listen for reflections. In an example implementation, such testing may comprise instructing a user to lay phone on a solid surface (e.g., first on its back and then its face) and without any external/after-market case on and emit and detect reflections. In another example implementation, the surface wave sensing can be paired with motion detection and touch screen/hand-held detection to determine when to attempt sensing. That is, such sensing may be performed in response to sensor input indicating that it is a good time to test. Such testing may be triggered based on, for example, current time, and output from motion sensors, gyroscope, back-facing camera, and front-facing camera. For example, in the middle of the night when both cameras are picking up little light and the device hasn't moved for two hours, it may be determined that the device's user is probably sleeping and now is a good time to perform the testing. As another example, the testing may be triggered in response to detecting a sudden acceleration (e.g., a drop/impact detection). The reflections gathered during the testing may be compared to historical reflections (e.g., performed in the factory and/or in the field) for the same device and/or different devices of the same make and model. Changes in the detected reflections relative to historical reflections may indicate a crack in the touchscreen or housing. The user may be prompted to look for a crack and attest to the presence of absence of a crack (e.g., an offer from an affiliate may be contingent on the user's affirmance that a crack is not present despite the reflections indicating otherwise). The acoustic wave source can be driven via tether power for detection even when battery power and other internal processing resources are not working. For performing such function, the client device may comprise additional tether associated processing circuitry that could be independent of the core processor which might not then be needed to be powered up for detection processing. FIGS. 9A and 9B can also similarly be tether driven. Such tether drive can be the secondary approach with the primary being via internal battery power and internal core processing and analysis.

Audio may also be used to detect internal rattling (perhaps of a disconnected cable or broken component). This can be handled by the current external or an additional internal microphone or both. By noticing via an internal accelerometer that the device rattle increases volume with increased shaking force plus that the internal microphone sound detected is louder than the external microphone sound, and based on the frequency components of the sound, the internal dislodgement can likely be identified. To assist in replacement of this audio detection scheme, an internal camera element can be added. Moving and missing components, cables, etc., and casing or screen cracks can then be visually seen. Such internal camera can also be tuned to infrared detection frequencies so that unusual heat patterns can be used to both identify current malfunctions and make breakdown predictions. In other words, via internal device installations, audio and visual sensors (and associated emitters that may operate without or outside of human perceptible ranges) can be used to identify malfunctions and onsets thereof.

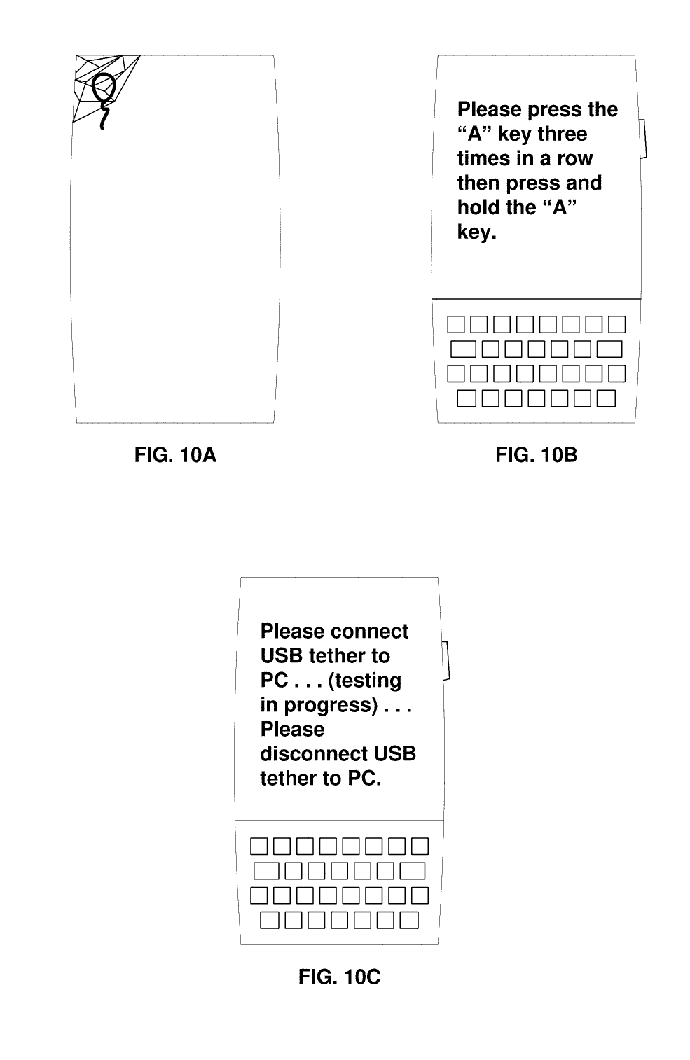

Cracks in a touchscreen of the client device may be tested for through a graphical and/or audio interface that guides a user to interact with the touchscreen. For example, user can be instructed to trace a pattern (e.g., a raster pattern) on the touchscreen with his her finger or stylus, or press different locations on the touchscreen in response to prompts. As an example, FIG. 10A shows the testing presented as a game in which balloons are presented on the screen and the user is directed to tap on the balloons to pop them. After each pop, the balloon can be moved. A cracked screen can be detected based on abnormalities in the touch area. The cracked screen in the device of FIG. 10A may be detected when the user doesn't (can't) pop the balloon shown in the top left corner of the screen. Upon detecting a crack, a work-around may be invoked as further described below.

Failed or failing (e.g., intermittent) hard controls (sticks, pens, keypads, etc.) may be tested for through a graphical and/or audio interface that guides a user to interact with the controls. For example, the PSS test software may direct a key-by-key test of a keyboard, power buttons, rocker buttons, etc., as, for example, shown in FIG. 10B. Detection of a failed or failing hard control may trigger a work-around such as those described below with reference to FIG. 13B.

Failed or aging connectors may be tested for by instructing the user to connect particular cables and devices to the device under test, execute code to exercise all of the pins, speeds, configurations, etc. of the connector, and then instructing the user to disconnect the cables and devices. For example, a user may be instructed to connect the device under test to a PC using a USB cable. PSS test code may then be executed on the device under test and/or the PC to test the USB port of the device under test.

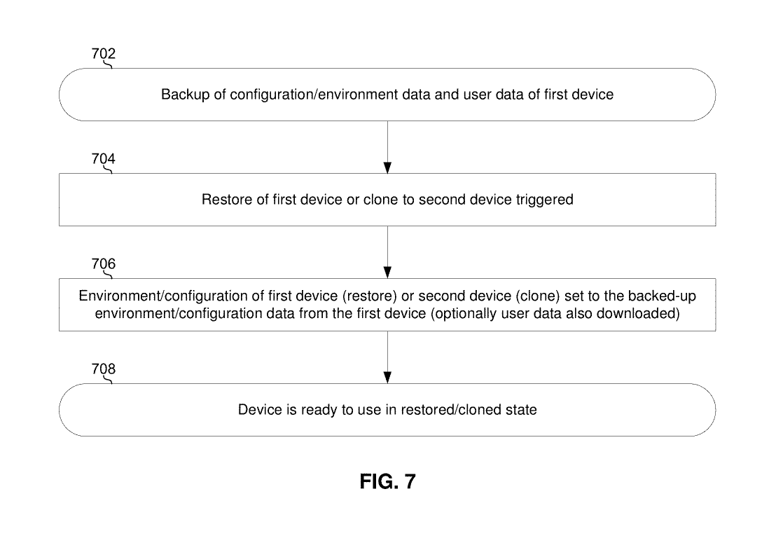

FIG. 7 is a flowchart illustrating a backup and restore/cloning service of a PSS system. In block 702, configuration/environment data and user data of a first client device is backed-up (e.g., to itself, to another client device, and/or PSS server, as described above). In an example implementation, configuration/environment data may be treated differently than user data for privacy/security purposes (e.g., stored to different locations, user data may first be anonymized, encrypted, etc.). In block 704 a restore or clone is triggered. A restore may be triggered, for example, based on detection (e.g., by a user and/or during the functional and/or cosmetic testing service of the PSS system) of a problem with the first client device. A clone may be triggered by, for example, a new device being added to the user's PSS account and selecting “clone first device to this device.” As another example, a clone may be triggered by clicking a hyperlink to download a clone app/installer or to launch a clone web service. The hyperlink may be presented in the GUI of the web service and/or may be sent/shared (e.g., via email). In block 706, the environment/configuration of the first client device (in the case of a restore) or a second client device (in the case of a clone) is configured according to the backed-up environment/configuration data from the first client device. Optionally (e.g., based on preferences and/or permissions established by the owner of the first client device) backed-up user data may be downloaded to the first device (in the case of a restore) or to the second client device (in the case of a clone). Before restoring or cloning, the current configuration/environment data and/or user data may be backed up such that the device can be revert to the pre-restore state if the restore has undesired effects. The state saved upon triggering of the clone or restore may be analyzed for malware etc. In the case of a clone where the second device is different than the first device (e.g., different make, model, OS, etc.), the PSS system may translate/port configuration/environment data for use with the new device to the extent possible and then alert the user as to the configuration/environment data that cannot be cloned exactly and/or the similarities and differences that will exist between the first device and the second device after the clone. Other efficiency and resource management functionality can be applied to backed-up configuration/environment data and/or user to create suggestions for a user to accept before modifying a restore installation (e.g., alerting the user to environment settings that hinder performance of features that the user's usage data indicates are important to that user, alerting the user that certain files have not been used for a long time and perhaps should not be downloaded during the clone/restore, and/or the like). In block 708, the restored or clone device is ready to use.

In an example implementation, the PSS system may associate different sets of backed-up data with corresponding usage data and/or corresponding test data. For example, backed-up data saved January 1 may be stored along with results from functional and cosmetic testing performed on January 1 and backed-up data saved February 1 may be stored along with results from functional and cosmetic testing performed on February 1. Looking at the corresponding test results may enable the user to choose the best restore data to use.

For example, if the test data from January 1 indicates no problems but the test data from February 1 indicates that excessive temperatures (e.g., because of malware or a poorly designed app causing excessive power consumption), the user may choose to restore to the January 1 data.

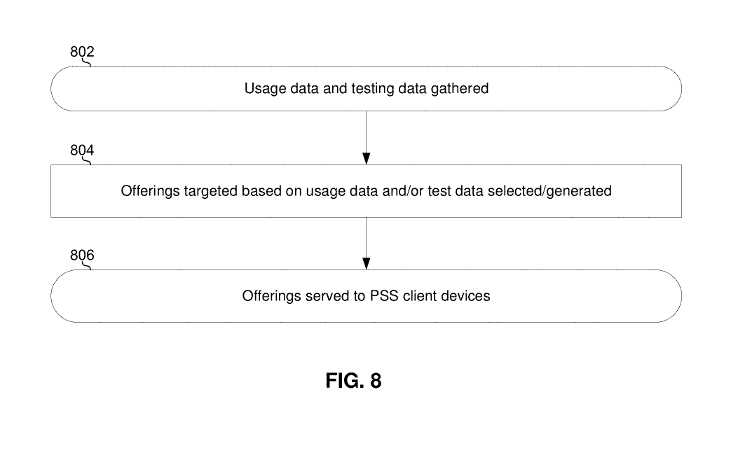

FIG. 8 is a flowchart illustrating a targeted offerings service of the PSS system. In block 802, data resulting from the performing the usage monitoring service and the functional and cosmetic testing service on a PSS client device is made available to the software and hardware providing the targeted offerings service of the PSS system. In block 804, offerings targeted at the particular PSS client device and/or its user or owner are selected (if affiliates have provided pre-generated offers along with criteria/guidelines as to the devices and/or users the offer should be served to) or generated (i.e., customized based on the data received in block 802). In block 806, the selected or generated offerings are served to the client device and/or to other client devices on the same PSS account.

Thus, offerings for recycling, replacing, reselling, and/or repairing the particular client device; for carrier/operator switchover and/or upgrade/downgrade for the particular client device; for apps, accessories, and/or third-party services available/suitable for the particular client device (e.g., new batteries, chargers, international power plugs, screen savers (post new screen replacement), carrying cases (after case cracks for aesthetics and to prevent future/further cracking), screen gel repair (for minor but growing screen cracks), memory upgrades (when the device's memory is maxed out), audio peripherals (when the device's sound setting is always maxed indicating need for more volume), and so on); and/or the like may be custom selected/generated based on test data and usage monitoring data (current device usage, status, repair needs, cost, predicted failure date (e.g., based on mean time to failure statistics), etc.) for that particular device and/or user and then served to that particular device and/or user/owner in a manner determined most suitable/effective for that device and/or user/owner. For example, offerings may be may be selected/customized not only based on user profile data, but based on the PSS client device's capabilities and usage of such capabilities versus available upgrade device performance for used capabilities, for example. As another example, offerings may be selected/customized based on current carrier/operator contract and usage of the PSS client device versus available upgrades/downgrades from competing carriers/operators. As another example, the offerings may be customized based on device aging determined from usage and/or test data, expected device life expectance based on usage and/or test data, and so on. As another example, offerings may be customize based on current operational state of the PSS client device (based on most-recent functional and cosmetic testing) and historical errors/problems detected during usage monitoring and/or functional and cosmetic testing. The Offerings may be selected/generated while keeping the particular device and/or its user's information hidden from the affiliates (e.g., with only identifying the number of recipients beforehand and associated fees to be paid to the PSS provider). As another example, an operator might offer a competing, lower-cost service package based on noticing a low volume evening, medium volume late night/early morning weekday, and no volume weekend use for a particular device and/or user, all in view of a different operator's current high-cost package. As another example, a phone seller may offer a rugged replacement for a user that keeps breaking screens. As another example, a carrier may offer a leasing program or lower cost insurance to non-destructive light fingered users at reduced rates. As another example, for a device for which a crack in the case has been detected, offerings for a case replacement (do-it-yourself), case glue/moisture barrier, case tape, or other accessories to repair or at least prevent further damage may be presented.

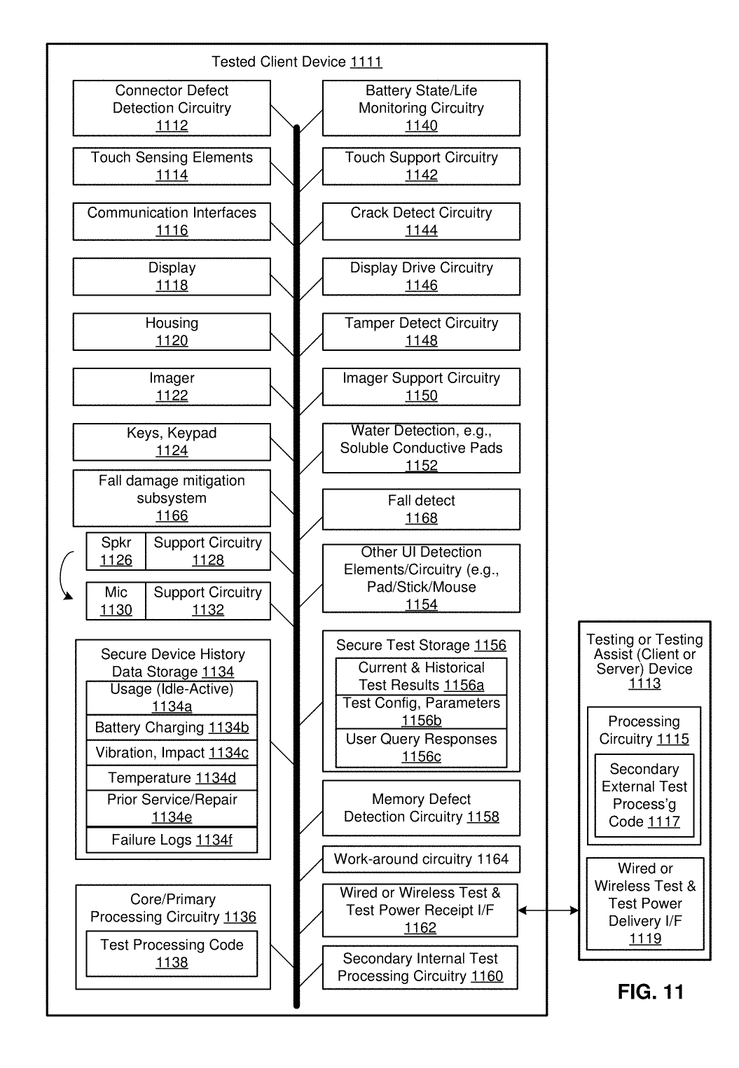

FIG. 11 illustrates example components of a PSS client device, each of which may itself be tested and/or assist in testing other components of the PSS client device, as part of the functional and cosmetic testing service of the PSS system. The shown device 1111 is an example implementation of the device 202 of FIG. 2A. The device comprises:

Connector Defect Detection Circuitry 1112 operable to test physically test the connectors/conductors (E.g., using transmission line reflection analysis, cross over conductivity/transmissions, and/or the like) and/or track usage of connectors of the device 1111 (e.g., may track insertions of cables to the connectors, active time/amount of current passing through the connector over time, etc.) for predicting life expectancy/failure of the connectors. For a failed USB connector, for example, the connector defect detection circuitry may invoke work-around code that re-routes communications from the failed USB connector to a wireless interface. Corresponding code on a peer device may enable the peer device to receive the communications via the wireless interface and then output them via its own USB connector. In this manner the peer device's USB connector may be operated as work-around hardware for the failed USB connector of the managed device.

Battery State/Life Monitoring Circuitry 1140 operable to physically test the battery (e.g., check that the battery properly charges when connected to an external power source, track the battery's maximum charge over time, etc.) and track usage of the battery of the device 1111 (e.g., number of charge cycles, average or peak currents, etc.) to predict life expectancy/failure of the battery. The Battery State/Life Monitoring Circuitry 1140 may comprise a test interface that enables testing the battery via a tether (point-to-point power delivering connection such as USB) even when the device 1111 is not booted up. Upon detecting a failing battery, Battery State/Life Monitoring Circuitry 1140 may invoke work-around code that, for example, alters the battery charge indicator to give a more accurate assessment of remaining energy, or work-around code that causes the device to demand a tethered connection before beginning any task that will likely not complete before the failing battery runs out of energy.

Touch sensing elements 1114 and associated touch support circuitry 1142 operable to provide touchscreen capabilities of the device 1111 and may be tested by the PSS system in a manner such as described above with respect to FIGS. 9A-9C, for example. Detection of a failed or failing touch sensing element may trigger a work-around such as described below.

Communication interfaces 1116 which may include, for example, bus hosts/drivers and may be, for example, tested along with connectors to which they are connected (for busses interfaces that extend external to the device 1111) as described above. For internal-only busses/interfaces, they may be tested by, for example, by bypassing the main OS/boot sequence of the device 1111 and performing direct testing of the bus (e.g., through a wirelessly or USB accessible JTAG or similar interface). Additionally, or alternatively, the interfaces may be configurable into a loopback mode such that an interface's own transmitter may be used to test its own receiver, and vice versa. Detection of a failed interface may trigger a work-around such as described above where communications are re-routed and corresponding code on a peer device enables the peer device to share its communication interfaces as work-around hardware.

Display drive circuitry 1146 operable to drive the display for normal operation and drive the crack detect circuitry.

Crack detect circuitry 1144 operable to detect cracks in the screen/touchscreen and/or housing, as discussed above. In response to detecting a crack, crack detection circuitry 1144 may invoke work-around code that reconfigures the display drive circuitry to alter the presentation of images (e.g., cropping, rearranging, scaling, etc. as described herein to avoid the cracked portion and/or to put less important content in the cracked portion).

Tamper detect circuitry 1148 operable to provide a physical indication that the housing has been opened and/or the device 1111 has otherwise been tampered with.

Imager 1122 (e.g., CMOS or CCD) and imager support circuitry 1150 operable to capture pictures. The PSS system may testing the imager (e.g., for a cracked or distorted lens) by instructing the user to take pictures of certain things (e.g., of a flat, uniformly-colored surface, of a test pattern displayed on another client device), for example. In response to detecting a defect, imager support circuitry 1150 may invoke work-around code that alters how pixel data from the Imager 422 is captured and/or subsequently processed (e.g., cropping, rearranging, scaling, averaging of surrounding pixels to replace the output of a bad pixel, etc., similar to as described for the display, to avoid the defective portion(s)).

Keys, Keypad 1124 which may be tested as described above. Detection of a defective key may trigger work-around code as, for example, described with respect to FIG. 13B.

Water Detection circuitry 1152 (e.g., Soluble Conductive Pads) which may indicate whether the device 1111 has been exposed to water. The water detection circuitry 1152 may comprise a test interface that enables detecting whether water was present via a tether, even when the device 1111 is not booted up.

Fall detection sensor(s) and logic 1168 comprises, for example, one or inertial measurement units (IMUs), each of which may comprise one or more accelerometers, one or more gyroscopes, and one or more magnetometers and/or the like. Fall detection sensor(s) also comprise logic 1168 logic operable to process the outputs of the sensor(s) and/or pixel data from imager 1122 to detect when the device 1111 is falling (the detection may be in terms of a probability that the device 1111 is falling). The output of the IMU and/or pixel data being captured and output by imager 1122 may indicate an acceleration and rotation consistent with falling. For example, a fall detection threshold may be set low for the IMU such that even a small possibility of falling triggers the imager 1122 to start capturing images and analysis of the images may then be used to confirm that the device is falling. The opposite scenario may also be used—imagers indicating possible falling may trigger analysis of the IMU to confirm or refute that the device 1111 is falling. Upon determining (with sufficient confidence) that the device 1111 is falling, it may alert fall damage mitigation subsystem 1166.

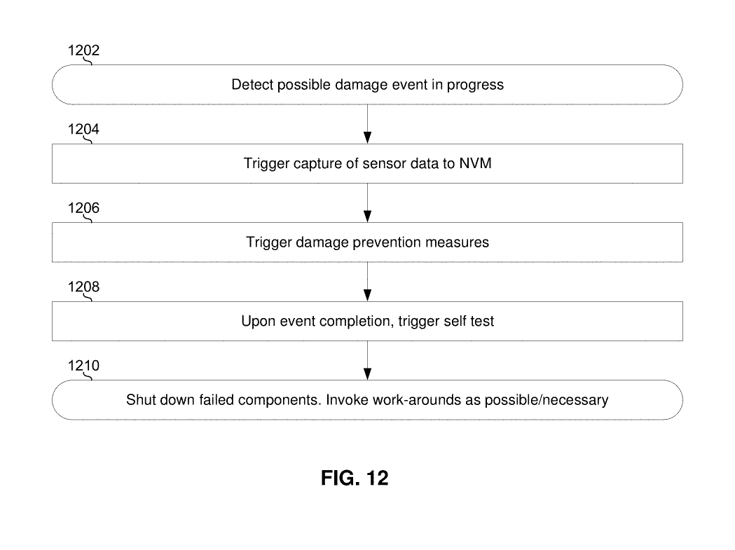

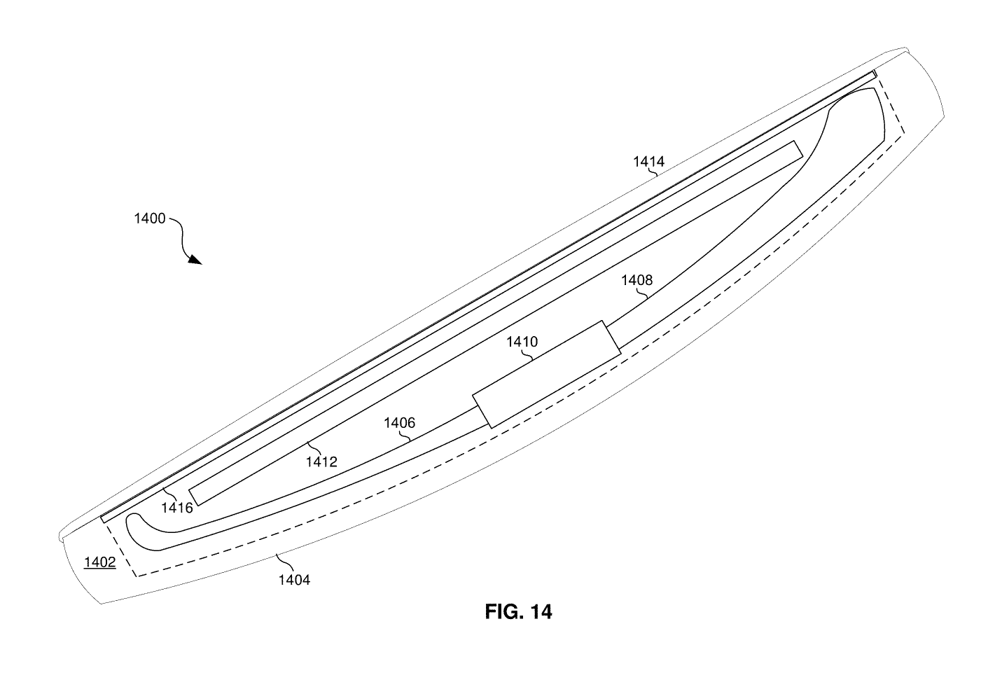

Fall damage mitigation subsystem 1166 comprises circuitry and/or mechanical components operable to reduce the damage that may result from the impact after a fall. The subsystem 1166 may, for example, shut down electrical components, close any electromechanical lenses, shutters, antennas, etc., deploy impact absorbing systems (e.g., air bags and/or magnetorheological or electrorheological fluid), and/or attempt to control the surface(s) which impact the ground (e.g., my altering a rotational momentum of the falling device). Further details regaing impact mitigation are described below with respect to FIGS. 12 and 14.

Speaker 1126 and associated support circuitry 1128 which may provide for audio output and which may be tested by, for example, setting the volume to a particular level, playing a particular sound or sounds via the speaker, capturing the sound via the microphone of the device (or microphone of another client device), and then analyzing the captured audio. Upon detection of a defective speaker, support circuitry 1128 may invoke work-around code that, for example, converts stereo audio to mono and outputs the mono audio to a good speaker while muting the defective speaker.

Microphone 1130 and associated support circuitry 1132 which may provide for audio input and which may be tested by, for example, setting the volume to a particular level, playing a particular sound or sounds (audible or even ultrasonic) via the speaker (or via speaker of another client device), capturing the sound via the microphone of the device, and then analyzing the captured audio.

Other UI Detection Elements/Circuitry 1154 (e.g., Pad/Stick/Mouse) which may provide for other methods of user input and may be tested as described above. Detection of defective UI Detection Elements/Circuitry may trigger work-around code similar, for example, to the work-arounds described below with respect to FIG. 13B.

Device History Data Storage 1134 operable to store (e.g., encrypted in nonvolatile memory such that it is hidden from third-party apps) data generated by a usage monitoring service of the PSS system. The data my include, for example, usage data 1134a (e.g., idle time vs. active time for the device as a whole and/or individual components), Battery Charging history 1134b, data 1134C from sensors of fall detect circuit 1168, and temperature sensor data 1134d, Prior Service/Repair logs 1134e, hardware and/or software failure logs 1134f (e.g., including work-arounds in place), and/or the like. In an example implementation, data stored in the device history data storage 1134 may be for a device other than the device 1111 (e.g., another device on the same PSS account where, for example, the device 1111 operates as a managing and monitoring device for the other client device). The device history data storage 1134 may comprise a test interface that enables reading its contents via a tether, even when the device 1111 is not booted up.

Test Storage 1156 operable to store (e.g., encrypted in nonvolatile memory such that it is hidden from third-party apps) data generated by the functional and cosmetic testing service of the PSS system. The data may include, for example, current and historical test results 1156a, test configuration parameters 1156b, user responses to queries presented during testing 1156c, and/or the like. In an example implementation, data stored in the test storage 1156 may be for a device other than the device 1111 (e.g., another device on the same PSS account where, for example, the device 1111 operates as a managing and monitoring device for the other client device). The test storage 1156 may comprise a test interface that enables reading its contents via a tether, even when the device 1111 is not booted up.

Memory Defect Detection Circuitry 1158 operable to test memory (DRAM, SRAM, HDD, FLASH, and/or the like which may be used for storage 1134 and/or 1156) including, for example, tracking read and write cycles, number of failed sectors, errors detected/corrected with forward error correction mechanisms and/or the like. The data may be used to detect existing defects and/or predict life expectancy/future defects. The memory defect detection circuitry 1158 may provide a test interface that is accessible via a tether such that the memory can be tested even when the device 1111 is not booted up. Upon detecting failed memory, the memory defect detection circuitry 1158 may invoke a work-around to supplement or replace the failed memory. For example, work around code may re-map memory addresses to external memory such as a flash drive or memory of a managing and monitoring device to which the device with the failed memory is tethered.

Work-around circuitry 1464 may, for example, comprise a redundant instance of hardware installed by the manufacturer of device 1411 (e.g., because it is hardware that is most likely to fail such as a storage system, a power supply, a bus controller etc. and the manufacture has deemed it more cost-effective to include redundant hardware rather than service PSS client devices or replace the devices as a whole). The work-around circuitry 1464 may, for example, comprise reconfigurable hardware (e.g., an FPGA, a general purpose processor, an EEPROM, and/or the like) which can be configured into any of a variety of configurations by loading/programming it with the appropriate work-around code for emulating whichever software and/or hardware has failed. The work-around circuitry 1464 may comprise non-volatile memory in which is stored work-around code for possible future failures and/or for existing failures.

Core/Primary Processing Circuitry 1136 is operable to execute test processing code 1138 in addition to operating system code and other application code executed as part of normal operation of the device 1111. Code executed by the core/primary processing circuitry 1136 may be altered by, replaced by, or supplemented with work-around code when defects are present.

Secondary Internal Test Processing Circuitry 1160 is operable to handle execution of test code when the core/primary processing circuitry is bypassed or disabled (e.g., for directly testing hardware components by selectively powering them up and down without interference from, or causing problems to, the core/primary circuitry or the operating system or third-party apps installed on the device 1111). When defects are detected during such testing the Secondary Internal Test Processing Circuitry 1160 may be operable to load work-around code (e.g., reconfigure one or more software applications with work-around code and/or flash work-around firmware to an EEPROM).

Wired or Wireless Test & Test Power Receipt interface 1162 comprises circuitry operable to receive power from an external source (e.g., when the battery of the device 1111 has failed), use the power for performing functional and cosmetic testing (either controlled by the core/primary processing circuitry, secondary internal test processing circuitry, and/or external secondary test processing circuitry), and download/install work-around code even when the device 1111 is not booted up.

Testing or Testing Assist (Client or Server) Device 1113 (Processing Circuitry(Secondary External Test Processing Code)) may be another client device that, for example, provides power via power delivery interface circuitry 1119 while the core/primary test processing circuitry 1136 executes test code to test the device 1111, provides power while the secondary internal test processing circuitry 1160 executes test code to test the device 1111, that provides power and provides secondary external test processing circuitry 1115 to execute test code 1117 for testing the device 1111, and/or provides work-around hardware and/or code for the device 1111. For hardware work-around, as much or as little of the hardware of the device 1113 as necessary to achieve a desired functionality may be substituted for failed hardware of the device 1111. In an example implementation, device 1113 may be the same make and model 1111, or the same make and a newer model, as device 1111.

FIG. 12 illustrates a process for automatic damage prediction, prevention, and remediation. In block 1202, sensors of a PSS client device (e.g., 1168, FIG. 11) detect that damage is possibly about to occur. For example, an accelerometer and gyroscope detect that the device is falling (and it is predicted that damage may occur upon landing). As another example, a moisture sensor (e.g., 1152, FIG. 11) in an outer/non-sensitive area detects moisture (and it is predicted that damage may occur upon water seeping into more sensitive areas). In block 1204 a capture of sensor data is triggered in response to the detection of block 1202. For example, the device's camera (e.g., 1122 and 1150, FIG. 11) and microphone (e.g., 1130 and 1132, FIG. 11) may begin recording and the captured audio and video may be stored to non-volatile memory. The image data may be used to confirm that the device is in fact falling and, furthermore, if damage does end up occurring, the audio and video data may provide evidence as to how the damage occurred. In block 1206, damage prevention measures are triggered (e.g., by subsystem 1166, FIG. 11). For example, upon detecting moisture the device may shut down rapidly in an attempt to prevent short circuiting.

As another example, referring briefly to FIG. 14, shown is a device 1400 (an example implementation of a PSS client device 202) comprising a cavity 1402 inside of an outer shell 1404, two bladders 1406 and 1408 connected by a micropump 1410, electronics 1412, a display 1416, and a dynamic screen protector 1414. The cavity 1402 may be filled with an impact cushioning foam or fluid. For example the fluid may be a magnetorheological or electrorheological fluid and the detection of falling may trigger the generation of a field that controls the viscosity of the fluid (possibly in multiple different regions) in an effort to absorb the impact at the predicted (based on sensor data) point of impact. The micropump (possibly solenoid type) 1410 operates to move fluid between the two bladders 1406 and 1408. In response to a detection of falling, the micropump 1410 may shift the fluid between the two bladders 1408 and 1410 based on sensor data in an attempt to alter the center of mass of the device 1400 such that air resistance induces a torque that will cause the device 1400 to fall on its back (in the FIG. 14, bladder 1408 is larger indicating the fluid has been shifted there). The curved back of the device 1400 may facilitate this increased likelihood of landing on the back instead of on the display 1416). In another implementation, the device 1400 may comprise a gyroscope of sufficient mass to alter the rotation of the device 1400 as it falls, which may be operated in a similar manner (in an effort to increase the likelihood of the device 1400 landing on its back). In an example implementation, the dynamic screen protector 1414 may be filled with a fluid that is normally free flowing fluid and thus thin, but when activated (e.g., by a magnetic or electric field, or by another micropump) could expand to protect the display 1416, thus providing a sort of “air bag.” The dynamic screen protector 1414 may cover entire display 1416 or just the perimeter (e.g., on the display 1416 itself, on the bezel, and/or on the edges of the device 1400).

Returning to FIG. 12. in block 1208, after the possibly damaging even is over, the device may trigger a self-test. In block 1210 if any failures are detected during the testing, the failed hardware may be shutdown so as not to waste power. Additionally, one or more work-arounds may be put into place such that the device can “limp along” with some minimal functionality until it can be fixed or replace.

As one example of a work-around, upon detecting that the screen of the device is cracked, work around code may be loaded that prevents (e.g., by configuring display drive circuitry 1146, or configuring how processing circuitry 1138 outputs data to display drive circuitry 1146) information from being displayed on the cracked region. For example, referring to FIG. 13A and assuming the screen of device comprises R rows and C columns of pixels, upon detecting a crack that extends from column 0 to column c and from row 0 to row r, pixel data output to the screen may be scaled to avoid the region from pixel [0,0] to pixel [r,c] (that is the region 1302) and use only the region 1304 (in effect, treat the screen as if its resolution is [R−r]×[C−c] instead of R×C). Where the image can be scaled in a non-rectangular way, the region 1306 may also be used (e.g., when viewing a website, it may be that a HTML <div> or <span> can be pushed up into region 1306). Similarly, if the screen is still viewable in the cracked region but the touch elements in that region are non-functioning, work-around code may prevent display of interactive interface-elements (buttons, sliders, etc.) in the region 1302. As still another example, where the crack is in the middle, the work-around code may trigger a split-screen view with the two windows straddling the crack.

As another work-around example, upon detecting that a button of a device is broken, work-around code may re-assign the function (e.g., by configuring, through software, how processing circuitry 1136 interprets various user inputs) of that button to another button or sequence of user inputs. For instance, when the power button is broken, shaking the device three times (as detected by its sensors) may be reassigned to the display on/display off command normally performed by the power button. There may be power consumption by continuously monitoring for shaking, but it may still be less than having the screen always on and keep the device more useful than if the screen were always off. As another example, referring to FIG. 13B, upon detecting a failure of key 1314, work-around code may reassign a simultaneous pressing of butting 1310 and 1312 to be equivalent to pressing button 1314 and/or may cause a virtual key 1316 to be overlaid on the touchscreen and function equivalent to the physical key 1314. The work-around code may enable the user to select the button/buttons/inputs that s/he would like to use in place of the broken button.

As another work-around example, upon detecting failure of a wireless radio of the device, the work-around code may divert (e.g., through a software or firmware change to the communication interfaces 1116) transmissions intended for that radio to another radio of the device (e.g., data intended to be transmitted via a failed Wi-Fi radio may instead be transmitted via a cellular radio), or to a tether to use the radio of a managing and monitoring device tethered to the failed device (the managing and monitoring device may be running complementary work-around code for sharing its radio with the failed device).

As another work-around example, upon detecting failure of memory, the device may prompt the user to connect a USB memory stick and the work-around code may enable (e.g., by altering software and/or firmware of a memory controller of circuitry 1136) the device to use the memory stick as a substitute for the faulty internal memory.

An example implementation of this disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, aspects of this disclosure may be realized in hardware, software, or a combination of hardware and software. Aspects of this disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

As used herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As used herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled, or not enabled, by some user-configurable setting.

While the systems and methods herein have been described with reference to certain implementations, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all implementations falling within the scope of the appended claims.

What is claimed is:

1. A cellular phone device supported by a collocated user device and a remote system, the cellular phone device comprising:
interface circuitry operable to directly couple with the collocated user device;
a work-around functionality element;
a battery;
support circuitry operable to:
support analysis directed by the remote system via the collocated user device and interface circuitry;
respond to directions originating with the remote system to activate the work-around functionality element, the directions being based on the supported analysis.

2. The cellular phone device of claim 1, wherein the work-around functionality element comprises work-around program code from the remote system.

3. The cellular phone device of claim 1, wherein the communication interface is operable to support receipt of power for delivery to the support circuitry.

4. The cellular phone device of claim 1, wherein the communication interface is operable to support delivery of usage related information to the remote system for use in generation of a monetary valuation.

5. The cellular phone device of claim 1, wherein the communication interface is operable to support delivery of operational information to the remote system for use in generation of a monetary valuation.

6. The cellular phone device of claim 1, wherein the directions comprise program testing code.

7. The cellular phone device of claim 1, wherein the work-around functionality element provides work-around functionality for a broken mechanical key of the cellular phone device.

8. The cellular phone device of claim 1, wherein the work-around functionality element provides work-around functionality for a broken screen of the cellular phone device.

9. The cellular phone device of claim 8, wherein the work-around functionality element is operable to rearrange, crop, or scale images presented on the screen to avoid a broken area of the screen.

10. The cellular phone device of claim 1, wherein the work-around functionality element provides work-around functionality for a broken speaker of the cellular phone device.

11. The cellular phone device of claim 10, wherein the work-around functionality element is operable to adjust a frequency response output to the broken speaker.

12. The cellular phone device of claim 1, wherein the cellular phone device comprises one or more sensors.

13. The cellular phone device of claim 10, wherein the sensor is an impact sensor.

14. The cellular phone device of claim 13, wherein the support circuitry is operable to maintain log of impacts measured by the impact sensor.

15. The cellular phone device of claim 1, wherein:
the interface circuitry is operable to couple the cellular phone device to an auxiliary device; and
the support circuitry is operable to route signals through a hardware element of the auxiliary device as a work-around for a broken hardware element in the cellular phone device.

16. The cellular phone device of claim 15, wherein the auxiliary device is another cellular phone device.

17. The cellular phone device of claim 1, wherein the directions comprise code executable by the work-around functionality element.
